(19) United States
(12) Patent Application Publication
(10) Pub. No.: US 2023/0261729 A1
(43) Pub. Date: Aug. 17, 2023

(54) BEAM INDICATIONS FOR FACILITATING MULTICAST ACCESS BY REDUCED CAPABILITY USER EQUIPMENT

(71) Applicant: QUALCOMM Incorporated, San Diego, CA (US)

(72) Inventors: Min Huang, Beijing (CN); Chao Wei, Beijing (CN); Qiaoyu Li, Beijing (CN); Jing Dai, Beijing (CN); Wei Xi, Beijing (CN); Chenxi Hao, Beijing (CN); Kangqi Liu, San Diego, CA (US); Hao Xu, Beijing (CN); Changlong Xu, Beijing (CN); Wanshi Chen, San Diego, CA (US)

(21) Appl. No.: 18/003,576

(22) PCT Filed: Aug. 21, 2020
(86) PCT No.: PCT/CN2020/110499

§ 371 Date: Dec. 28, 2022

(51) Int. Cl. H04B 7/08; H04B 7/06

(52) U.S. Cl. CPC H04B 7/0888; H04B 7/0626; H04B 7/0857

(57) ABSTRACT

Aspects of the disclosure relate to transmitting, from a user equipment (UE) to a base station, information indicative of a multicast session that the UE is interested in accessing; transmitting information indicating that a first beam of a plurality of beams is a preferred beam for receiving multicast data associated with the multicast session; receiving, from the base station, a list of at least one beam of the plurality of beams associated with the multicast session; and receiving, from the base station using a beam from the list, multicast data associated with the multicast session. Other aspects, embodiments, and features are also claimed and described.

### TECHNICAL FIELD

The technology discussed below relates generally to wireless communication systems, and more particularly, to indicating one or more beams on which one or more multicast sessions are scheduled for transmission to reduced capability user equipment.

### INTRODUCTION

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method of wireless communication at a user equipment is disclosed. In a more particular example, the method includes: transmitting, from a user equipment (UE) to a base station, information indicative of a multicast session that the UE is interested in accessing; transmitting information indicating that a first beam of a plurality of beams is a preferred beam for receiving multicast data associated with the multicast session receiving, from the base station, a list of at least one beam of the plurality of beams associated with the multicast session; and receiving, from the base station using a beam from the list, multicast data associated with the multicast session.

In another example, a wireless communication device is disclosed. In a more particular example, the wireless communication device includes: a transceiver; memory; and a processor communicatively coupled to the transceiver and the memory, the processor configured to: transmit, to a base station via the transceiver, information indicative of a multicast session that the wireless communication device is interested in accessing; transmit, via the transceiver, information indicating that a first beam of a plurality of beams is a preferred beam for receiving multicast data associated with the multicast session receive, from the base station via the transceiver, a list of at least one beam of the plurality of beams associated with the multicast session; and receive, using a beam from the list, multicast data associated with the multicast session.

In another example, a wireless communication device is disclosed. In a more particular example, the wireless communication device includes: means for transmitting, to a base station, information indicative of a multicast session that the wireless communication device is interested in accessing; means for transmitting information indicating that a first beam of a plurality of beams is a preferred beam for receiving multicast data associated with the multicast session means for receiving, from the base station, a list of at least one beam of the plurality of beams associated with the multicast session; and means for receiving, from the base station using a beam from the list, multicast data associated with the multicast session.

In another example, a non-transitory processor-readable storage medium storing processor-executable programming is disclosed. In a more particular example, the non-transitory processor-readable storage medium stores processor-executable programming for causing a processing circuit to: transmit, from a user equipment (UE) to a base station, information indicative of a multicast session that the UE is interested in accessing; transmit information indicating that a first beam of a plurality of beams is a preferred beam for receiving multicast data associated with the multicast session receive, from the base station, a list of at least one beam of the plurality of beams associated with the multicast session; and receive, from the base station using a beam from the list, multicast data associated with the multicast session.

In another example, a method of wireless communication at a base station is disclosed. In a more particular example, the method, includes: transmitting, to one or more user equipments (UEs), a list of at least one beam of a plurality of beams associated with a multicast session that the one or more UEs are interested in accessing; and transmitting multicast data associated with the multicast session using the at least one beam from the list.

In another example, a scheduling entity is disclosed. In a more particular example, the scheduling entity includes: a transceiver; a network interface; memory; and a processor communicatively coupled to the transceiver and the memory, the processor configured to: transmit, to one or more user equipments (UEs) via the transceiver, a list of at least one beam of a plurality of beams associated with a multicast session that the one or more UEs are interested in accessing; and transmit, via the transceiver, multicast data associated with the multicast session using the at least one beam from the list.

In another example, a scheduling entity is disclosed. In a more particular example, the scheduling entity includes: means for transmitting, to one or more user equipments (UEs), a list of at least one beam of a plurality of beams associated with a multicast session that the one or more UEs are interested in accessing; and means for transmitting multicast data associated with the multicast session using the at least one beam from the list.

In another example, another non-transitory processor-readable storage medium storing processor-executable programming is disclosed. In a more particular example, the non-transitory processor-readable storage medium stores processor-executable programming for causing a processing circuit to: transmit, to one or more user equipments (UEs), a list of at least one beam of a plurality of beams associated with a multicast session that the one or more UEs are interested in accessing; and transmit multicast data associated with the multicast session using the at least one beam from the list.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system in accordance with some aspects of the disclosed subject matter.

FIG. 2 is a conceptual illustration of an example of a radio access network in accordance with some aspects of the disclosed subject matter.

FIG. 3 is a block diagram illustrating a wireless communication system supporting multiple-input multiple-output (MIMO) communication in accordance with some aspects of the disclosed subject matter.

FIG. 4 is a schematic illustration of an organization of wireless resources in an air interface utilizing orthogonal frequency divisional multiplexing (OFDM) in accordance with some aspects of the disclosed subject matter.

FIG. 5 is a block diagram conceptually illustrating an example of an architecture that can be used to generate directed beams in accordance with some aspects of the disclosed subject matter.

FIG. 6A is a schematic illustration of beam indices associated with various portions of a cell in accordance with some aspects of the disclosed subject matter.

FIG. 6B is a schematic illustration of beam indices of various beams that can be used to transmit one or more multicast sessions based on reports from various reduced capability user equipments in accordance with some aspects of the disclosed subject matter.

FIG. 7 is a block diagram conceptually illustrating an example of a hardware implementation for a scheduling entity in accordance with some aspects of the disclosed subject matter.

FIG. 8 is a block diagram conceptually illustrating an example of a hardware implementation for a scheduled entity in accordance with some aspects of the disclosed subject matter.

FIG. 9 is a signaling diagram illustrating exemplary signaling between a scheduling entity and a scheduled entity within a wireless communication system to schedule and transmit multicast data on one or more preferred beams of reduced capability user equipments in accordance with some aspects of the disclosed subject matter.

FIG. 10 is a flow chart illustrating an exemplary process for a scheduling entity to schedule multicast sessions on one or more beams for transmission to reduced capability user equipments in accordance with some aspects of the disclosed subject matter.

FIG. 11 is a flow chart illustrating an exemplary process for a scheduled entity to receive one or more multicast sessions on a preferred beam(s) in accordance with some aspects of the disclosed subject matter.

FIG. 12A is a schematic illustration of a technique for transmitting control information related to multicast data using wide beams, and beams that can be used to transmit multicast data in accordance with some aspects of the disclosed subject matter.

FIG. 12B is a schematic illustration of a technique for transmitting control information related to multicast data using beam sweeping, and beams that can be used to transmit multicast data in accordance with some aspects of the disclosed subject matter.

FIG. 12C is a schematic illustration of a technique for transmitting control information related to multicast data using beams selected for transmitting multicast data, and beams that can be used to transmit multicast data in accordance with some aspects of the disclosed subject matter.

FIG. 13 is a schematic illustration of beams that can be used to transmit reference signals, and beams that can be used to transmit multicast data associated with different multicast sessions to regular capability device and reduced capability devices in accordance with some aspects of the disclosed subject matter.

### DETAILED DESCRIPTION

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

While aspects and embodiments are described in this application by illustration to some examples, those skilled in the art will understand that additional implementations and use cases can come about in many different arrangements and scenarios. Innovations described herein can be implemented across many differing platform types, devices, systems, shapes, sizes, packaging arrangements. For example, embodiments and/or uses can come about via integrated chip embodiments and other non-module-component based devices (e.g., end-user devices, vehicles, communication devices, computing devices, industrial equipment, retail/purchasing devices, medical devices, artificial intelligence-enabled devices, etc.). While some examples may or may not be specifically directed to use cases or applications, a wide assortment of applicability of described innovations can occur. Implementations can range a spectrum from chip-level or modular components to non-modular, non-chip-level implementations and further to aggregate, distributed, or OEM devices or systems incorporating one or more aspects of the described innovations. In some practical settings, devices incorporating described aspects and features can also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein can be practiced in a wide variety of devices, chip-level components, systems, distributed arrangements, end-user devices, etc. of varying sizes, shapes and constitution.

Various concepts presented throughout this disclosure can be implemented across a broad variety of telecommunication systems, network architectures, and communication standards.

In LTE, a base station can multicast data to multiple UEs using a multimedia broadcast multicast service (MBMS) session. The base station can send a single cell multicast control channel (SC-MCCH) signal having downlink control information (DCI) that is scrambled with single cell radio network temporary identifier (SC-RNTI) to all user equipments (UEs) in the cell, configuring a number of multicast sessions, each of which is associated with a group RNTI (G-RNTI) value and a discontinuous reception (DRX) profile (cycle period, offset, on-duration length, inactivity-timer length, etc.). In order for a UE to receive multiple multicast sessions in LTE, the UE monitors a physical downlink control channel (PDCCH) at the on-duration occasions of different DRX profiles for all of the multicast sessions. For example, the UE can blindly decode PDCCH to search DCI which is scrambled with the configured G-RNTI values.

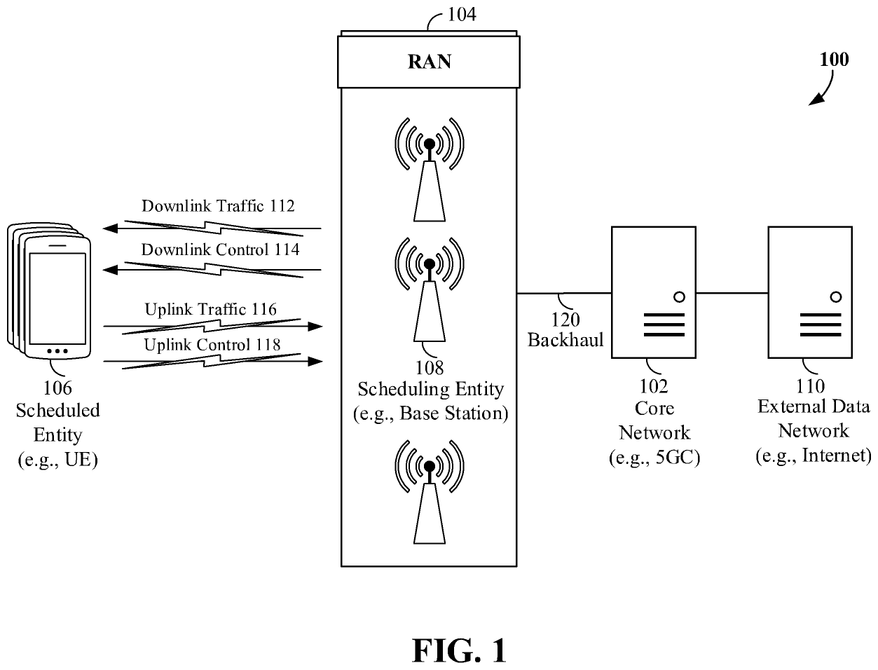

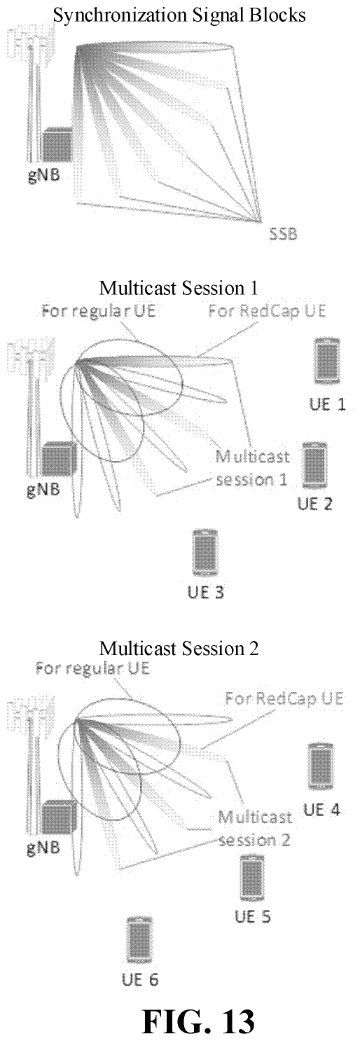

In 5G NR, beamforming can be used to increase directional gain for transmitted and/or received signals, which can increase data rate, reliability, and coverage, which can be especially useful for higher frequency signals (e.g., signals with a frequency of at least 6 gigahertz (GHz). Upcoming devices with reduced capabilities (e.g., reduced capability UEs described below in connection with FIG. 1), can be expected to fewer receive (Rx) antennas than some other devices, and weaker processing gain than some other devices causing worse reception performance. A base station can mitigate some of the performance limitations of such a reduced capability device by providing higher transmission beamforming gain, which can be achieved by using a narrow beam targeted at each such device covered by the base station (e.g., as described below in connection with, and shown in, FIG. 13).

In 5G NR, a base station can be expected to broadcast synchronization signal blocks (SSBs) to all UEs in a cell, which can be accomplished by transmitting the SSBs in every beam direction (e.g., using beam sweeping techniques). While multicast can be achieved by transmitting data associated with a multicast session on each beam using similar techniques, multicast data can be expected to have a much higher traffic load than SSBs, which would consume many radio resources transmitting such data, potentially to areas of the cell that do not have any UEs that are interested in accessing the multicast data, potentially wasting many radio resources. In some aspects, mechanisms described herein can facilitate multicast access by reduced capability UEs (and/or any other type(s) of UEs) by determining which beams to use to transmit the multicast data based on reported information on beam quality from the UEs.

FIG. 1 is a schematic illustration of a wireless communication system 100 in accordance with some aspects of the disclosed subject matter, and is described as an illustrative example without limitation. In some aspects, wireless communication system 100 can include three interacting domains: a core network 102, a radio access network (RAN) 104, and a user equipment (UE) 106. In some aspects, by virtue of wireless communication system 100, UE 106 can be enabled to carry out data communication with an external data network 110, such as (but not limited to) the Internet.

In some aspects, RAN 104 can implement any suitable wireless communication technology or combination of technologies to provide radio access to UE 106. For example, RAN 104 can operate according to 3^{rd} Generation Partnership Project (3GPP) New Radio (NR) specifications, which is sometimes referred to as 5G NR or simply 5G. As another example, RAN 104 can operate under a hybrid of 5G NR and Evolved Universal Terrestrial Radio Access Network (eUTRAN) standards, which is sometimes referred to as LTE. The 3GPP refers to this hybrid RAN as a next-generation RAN, or NG-RAN. Of course, many other examples can be utilized in connection with the subject matter disclosed herein without departing from the scope of the present disclosure.

As illustrated in the example of FIG. 1, RAN 104 includes various base stations 108. Broadly, a base station can be used to implement a network element in a radio access network responsible for radio transmission and reception in one or more cells to or from a UE, such as UE 106. In different technologies, standards, and/or contexts, various terminology has been used to refer to a network elements that act as a base station. For example, a base station can also be referred to by those skilled in the art using various terminology to refer to a network element that connects one or more UE apparatuses to one or more portions of core network 102, such as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

In some aspects, as illustrated in FIG. 1, RAN 104 can support wireless communication for multiple mobile apparatuses. A mobile apparatus can be referred to as user equipment (UE) in 3GPP standards, but can also be referred to by those skilled in the art using various terminology to refer to a network element that provides a user with access to one or more network services, such as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In general, a UE can be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs can include a number of hardware structural components sized, shaped, and arranged to facilitate communication; such components can include antennas, antenna arrays, RF chains, amplifiers, one or more processors, etc., electrically coupled to each other. For example, some non-limiting examples of a mobile apparatus include a mobile, a cellular (cell) phone, a smartphone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus can additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health and/or fitness tracker, a digital audio player (e.g., MP3 player), a camera, a game console, etc. A mobile apparatus can additionally be a digital home device or smart home device such as a home audio device, a home video device, and/or a home multimedia device, an appliance, a vending machine, intelligent lighting, a home security system, a smart meter, etc. A mobile apparatus can additionally be a smart energy device, a security device, a solar panel and/or solar array, a municipal infrastructure device controlling electric power (e.g., a smart grid), a municipal infrastructure device controlling lighting, a municipal infrastructure device controlling water, etc.; an industrial automation and enterprise device; a logistics controller; agricultural equipment; military defense equipment, vehicles, aircraft, ships, weaponry, etc. Still further, a mobile apparatus can provide for connected medicine or telemedicine support, e.g., health care at a distance. Telehealth devices can include telehealth monitoring devices and telehealth administration devices, whose communication may be given preferential treatment or prioritized access over other types of information (e.g., in terms of prioritized access for transport of critical service data, and/or relevant QoS for transport of critical service data).

In some aspects, user equipment 106 can be designated as a reduced capability UE (RedCap UE), which can also sometimes be referred to as NR-lite UEs, NR-light UEs, and low tier 5G UEs. RedCap UEs can address use cases for which eMTC, NB-IoT, eMBB, and/or URLLC are not well suited. For example, RedCap UEs can be used when an eMTC and NB-IoT have insufficiently low latency, insufficiently low reliability, and/or insufficient low peak data rates. As another example, RedCap UEs can be used when the low latency and/or high reliability provided by eMBB and URLLC are not required, and/or when the peak data rates required are not as high as the peak data rates provided by eMBB. In general, using a RedCap UE rather than a URLLC UE or eMBB UE can be expected to lower costs, provide longer battery life, and increase coverage, while increasing latency, and reducing reliability. Conversely, using a RedCap UE rather than an NB-IoT UE or eMTC UE can be expected to raise costs, reduce battery life, and reduce coverage, while reducing latency, increasing reliability, and increasing peak data rates. RedCap UEs can be well suited to a variety of use cases, such as in data intensive wearable devices (e.g., watches, eyewear, etc.), smart grid use cases, high accuracy and/or precision logistic trackers, remote healthcare monitoring, industrial imaging, security monitoring cameras, remote drone control, etc. In a particular example, a RedCap UE may have worse receiving performance compared to an eMBB UE due to the RedCap UE having fewer receiving (Rx) antennas and/or less processing resources dedicated to processing gain. In such an example, the RedCap UE may require a base station to provide higher transmission (Tx) beamforming gain to achieve suitable reliability. As another particular example, a RedCap UE may be used in an application for which increased battery life is desirable. In such an example, it is undesirable to attempt to increase reliability by receiving multiple versions of the same signal (e.g., a multicast session via multiple different beams), and using information extracted from the highest quality version of the received signal, as this may reduce battery life by receiving and/or decoding relatively low quality versions of the signal.

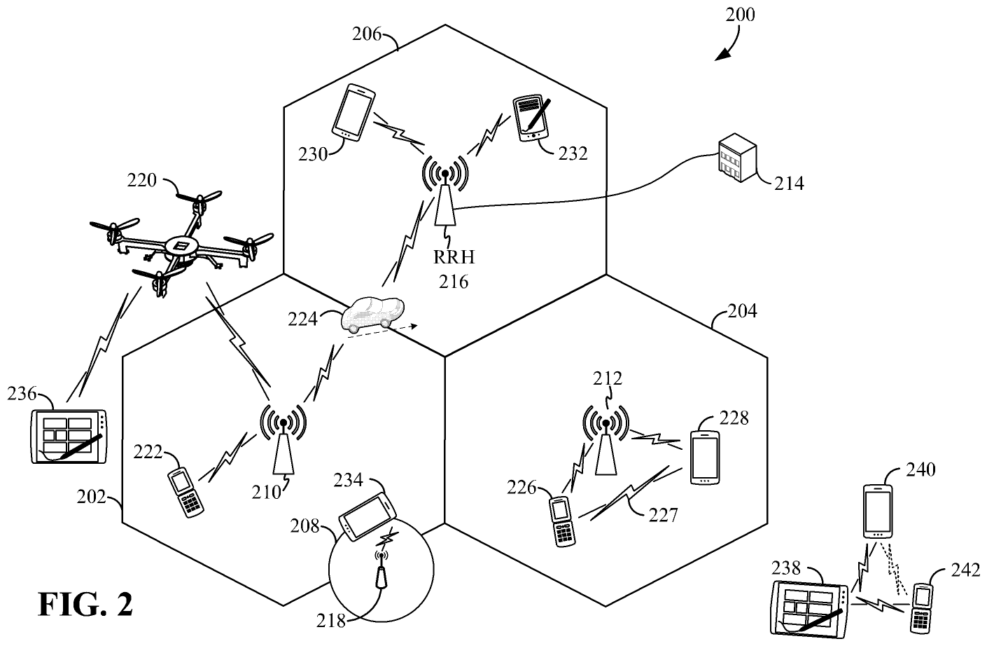

FIG. 2 is a conceptual illustration of an example of a radio access network 200 in accordance with some aspects of the disclosed subject matter, and is described as an illustrative example without limitation. In some aspects, RAN 200 can be an implementation of RAN 104 described above in connection with, and illustrated in, FIG. 1. In some aspects, the geographic area covered by RAN 200 can be divided into cellular regions (cells) that can be uniquely identified by a user equipment (UE) based on an identification broadcasted from one access point or base station. FIG. 2 illustrates macrocells 202, 204, and 206, and a small cell 208, each of which can include one or more sectors (not shown). For example, a sector can be defined as a sub-area of a cell, and all sectors within one cell can be served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are illustrated in cells 202 and 204; and a third base station 214 is shown controlling a remote radio head (RRH) 216 in cell 206. That is, a base station can have an integrated antenna or can be connected to an antenna or RRH by feeder cables. In the illustrated example, cells 202, 204, and 206 can be referred to as macrocells, as base stations 210, 212, and 214 support cells having a relatively large size. Further, a base station 218 is shown in small cell 208 (which can be referred to, for example, as a microcell, picocell, femtocell, home base station, home Node B, home eNode B, etc.) which can overlap with one or more macrocells. In the example illustrated in FIG. 2, cell 208 can be referred to as a small cell, as base station 218 supports a cell having a relatively small size. In some aspects, cell sizing can be done according to system design as well as component constraints.

It is to be understood that radio access network 200 can include any number of wireless base stations and cells. Further, a relay node can be deployed to extend the size or coverage area of a given cell. Additionally, base stations 210, 212, 214, 218 can provide wireless access points to a core network for any number of mobile apparatuses. In some examples, base stations 210, 212, 214, and/or 218 can be particular implementations of base station 108 described above in connection with, and illustrated in, FIG. 1.

FIG. 2 further includes a quadcopter 220 (which is sometimes referred to as a drone), which can be configured to function as a base station. That is, in some examples, a cell may not necessarily be stationary, and the geographic area of the cell can move according to the location of a mobile base station such as quadcopter 220.

Within RAN 200, the cells may include UEs that may be in communication with one or more sectors of each cell. Further, each base station 210, 212, 214, 218, and 220 can be configured to provide an access point to a core network 102 (e.g., as described above in connection with FIG. 1) for all the UEs in the respective cells. For example, UEs 222 and 224 can be in communication with base station 210; UEs 226 and 228 can be in communication with base station 212; UEs 230 and 232 can be in communication with base station 214 by way of RRH 216; UE 234 can be in communication with base station 218; and UE 236 can be in communication with mobile base station 220. In some examples, UEs 222, 224, 226, 228, 230, 232, 234, 236, 238, 240, and/or 242 can be particular implementations of UE 106 described above in connection with, and illustrated in, FIG. 1.

In some examples, a mobile network node (e.g., quadcopter 220) can be configured to function as a UE. For example, quadcopter 220 can operate within cell 202 by communicating with base station 210.

In some aspects, sidelink signals can be used between UEs without necessarily relying on scheduling or control information from a base station. For example, two or more UEs (e.g., UEs 226 and 228) can communicate with each other using peer to peer (P2P) or sidelink signals without relaying that communication through a base station (e.g., base station 212). In another example, UE 238 is illustrated communicating with UEs 240 and 242. In such an example, UE 238 can function as a scheduling entity or a primary sidelink device, and UEs 240 and 242 can function as scheduled entities or a non-primary (e.g., secondary) sidelink device. In yet another example, a UE can function as a scheduling entity in a device-to-device (D2D), peer-to-peer (P2P), vehicle-to-vehicle (V2V) network, and/or in a mesh network. In a mesh network example, UEs 240 and 242 can optionally communicate directly with one another in addition to communicating with a scheduling entity (e.g., UE 238). Thus, in a wireless communication system with scheduled access to time—frequency resources and having a cellular configuration, a P2P configuration, and/or a mesh configuration, a scheduling entity and one or more scheduled entities may communicate utilizing the scheduled resources.

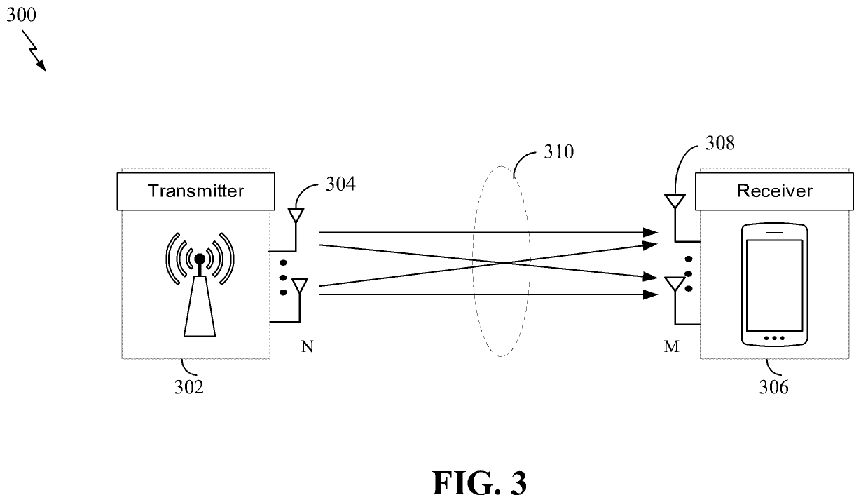

In some aspects of the disclosed subject matter, the scheduling entity and/or scheduled entity can be configured to implement beamforming and/or multiple-input multiple-output (MIMO) technology. FIG. 3 is a block diagram illustrating a wireless communication system 300 supporting MIMO communication in accordance with some aspects of the disclosed subject matter, and is described as an illustrative example without limitation.

Beamforming can generally refer to directional signal transmission or reception. For a beamformed transmission, the amplitude and phase of each antenna in an array of antennas can be precoded, or controlled to create a desired (e.g., directional) pattern of constructive and destructive interference in the wavefront. In a MIMO system, a transmitter 302 can include multiple transmit antennas 304 (e.g., N transmit antennas) and a receiver 306 can include multiple receive antennas 308 (e.g., M receive antennas). Thus, there are N×M signal paths 310 (e.g., corresponding to a DL transmission to receiver 306) from transmit antennas 304 to receive antennas 308. Each of transmitter 302 and receiver 306 can be implemented, for example, within a scheduling entity (e.g., base station 108), a scheduled entity (e.g., UE 106), or any other suitable wireless communication device. Additionally, in some aspects, each of transmitter 302 and receiver 306 can be implemented to operate as both a transmitter and a receiver. For example, receive antennas 308 (and/or corresponding transmit antennas of receiver 306) can be used to transmit signals, and transmit antennas 304 (and/or corresponding receive antennas of transmitter 302) can be used to receive signals. Thus, in such an example, there can be M×N corresponding signal paths (e.g., corresponding to a UL transmission to transmitter 308). Each of transmitter 302 and receiver 306 can be implemented, for example, within a scheduling entity 108, a scheduled entity 106, or any other suitable wireless communication device.

The use of such multiple antenna technology can enable the wireless communication system to exploit the spatial domain to support spatial multiplexing, beamforming, and transmit diversity. In a MIMO system, spatial multiplexing can be used to transmit multiple different streams of data, also referred to as layers, simultaneously on the same time-frequency resource. For example, in some aspects, a transmitter can send multiple data streams to a single receiver. In this way, a MIMO system can take advantage of capacity gains and/or increased data rates associated with using multiple antennas in rich scattering environments where channel variations can be tracked. Here, the receiver can track these channel variations and provide corresponding feedback to the transmitter. For example, as shown in FIG. 3, a simplest case can be illustrated using a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. Receiver 306 can then reconstruct the data streams using the received signals from each receive antenna 308.

In some examples, a transmitter can send multiple data streams to multiple receivers. This can generally be referred to as multi-user MIMO (MU-MIMO). In this way, a MU-MIMO system can exploit multipath signal propagation to increase the overall network capacity by increasing throughput and spectral efficiency, and reducing the required transmission energy. This can be achieved by spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. The receiver may transmit feedback including a quantized version of the channel so that the transmitter can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit antennas 304 or receive antennas 308, whichever is lower. In addition, the channel conditions at the receiving device, as well as other considerations, such as the available resources at the transmitting device, can also affect the transmission rank. For example, a base station in a cellular RAN can assign a rank (and therefore, a number of data streams) for a DL transmission to a particular UE based on a rank indicator (RI) the UE transmits to the base station. The UE can determine this RI based on the antenna configuration (e.g., the number of transmit and receive antennas) and a measured signal-to-interference-and-noise ratio (SINR) on each of the receive antennas. The RI can indicate, for example, the number of layers that can be supported under the current channel conditions. The base station can use the RI along with resource information (e.g., the available resources and amount of data to be scheduled for the UE) to assign a DL transmission rank to the UE.

The transmitting device can determine the precoding of the transmitted data stream or streams based, for example, on known channel state information of the channel on which the transmitting device transmits the data stream(s). For example, the transmitting device can transmit one or more suitable reference signals (e.g., a channel state information reference signal, or CSI-RS) that the receiving device can measure. The receiver can then report measured channel quality information (CQI) back to the transmitting device. This CQI generally reports the current communication channel quality, and in some examples, a requested transport block size (TBS) for future transmissions to the receiver. In some examples, the receiver can further report a precoding matrix indicator (PMI) back to the transmitting device. This PMI generally reports the receiving device's preferred precoding matrix for the transmitting device to use, and can be indexed to a predefined codebook. The transmitting device can then utilize this CQI/PMI to determine a suitable precoding matrix for transmissions to the receiver.

As described above, in Time Division Duplex (TDD) systems, the UL and DL are reciprocal, in that each uses different time slots of the same frequency bandwidth. Therefore, in TDD systems, a base station can assign a rank for DL MIMO transmissions based on an UL SINR measurement (e.g., based on a sounding reference signal (SRS) or other pilot signal transmitted from the UE). Based on the assigned rank, the base station can then transmit channel state information reference signals (CSI-RS) with separate sequences for each layer to provide for multi-layer channel estimation. From the CSI-RS, the UE can measure the channel quality across layers and resource blocks. The UE can then transmit a CSI report (including, e.g., CQI, RI, and PMI) to the base station for use in updating the rank and assigning resources for future downlink transmissions.

In order for transmissions over the radio access network 200 to obtain a low block error rate (BLER) while still achieving very high data rates, channel coding can be used. That is, wireless communication can generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for bit errors that may occur due to the noise.

In 5G NR specifications, user data can be coded using quasi-cyclic low-density parity check (LDPC) with two different base graphs: one base graph for large code blocks and/or high code rates, while the other base graph is used otherwise. Control information and the physical broadcast channel (PBCH) can be coded using Polar coding, based on nested sequences. For these channels, puncturing, shortening, and repetition are used for rate matching.

However, those of ordinary skill in the art will understand that aspects of the present disclosure can be implemented utilizing any suitable channel code. Various implementations of scheduling entities 108 and scheduled entities 106 can include suitable hardware and capabilities (e.g., an encoder, a decoder, and/or a CODEC) to utilize one or more of these channel codes for wireless communication.

The air interface in the radio access network 200 can utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (which is sometimes referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station 210 may multiplex DL transmissions to UEs 222 and 224 utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

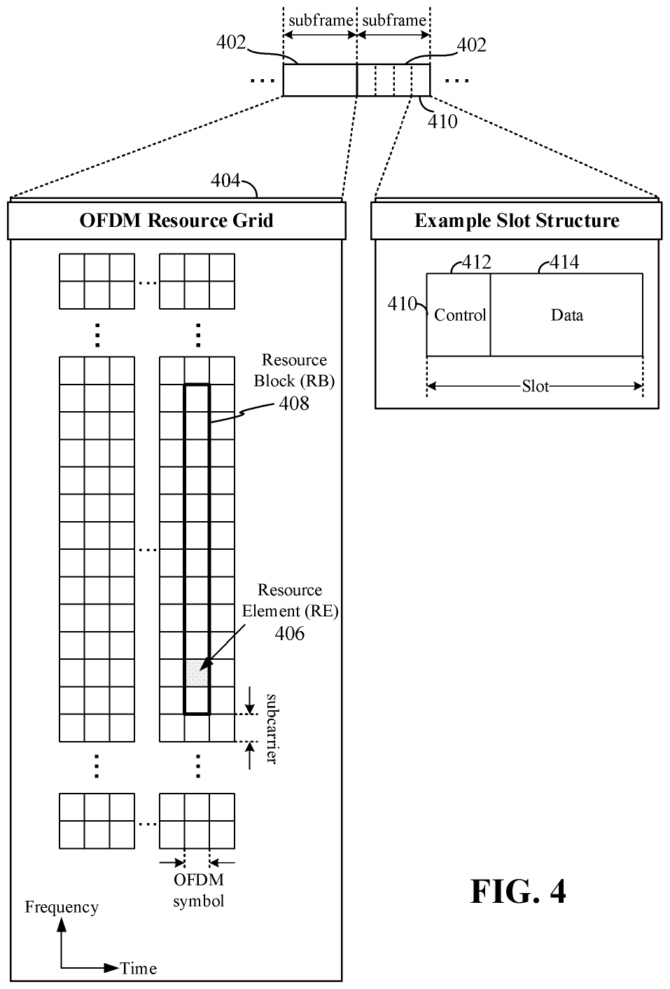

FIG. 4 is a schematic illustration of an organization of wireless resources in an air interface utilizing orthogonal frequency divisional multiplexing (OFDM) in accordance with some aspects of the disclosed subject matter, and is described as an illustrative example without limitation.

It should be understood by those of ordinary skill in the art that the various aspects of the present disclosure can be applied to a DFT-s-OFDMA waveform in substantially the same way as described herein below. That is, while some examples of the disclosed subject matter may focus on an OFDM link for clarity, it should be understood that the same principles can be applied as well to DFT-s-OFDMA waveforms. DFT-s-OFDM is a single carrier (SC)-like transmission scheme that can be used in conjunction with OFDM. In DFT-s-OFDM a data symbol can be encoded across multiple adjacent OFDM frequency resource elements (e.g., using multiple adjacent OFDM carriers), and the data symbols can be transmitted sequentially in the time domain. In OFDM, a data symbol can be encoded on a single frequency resource element (e.g., using a single OFDM carrier), and multiple data symbols can be transmitted in parallel on adjacent carriers. Signal processing in the transmit chains of OFDM and DFT-s-OFDM have many similarities, with DFT-s-OFDM utilizing an additional discrete Fourier transform (DFT) block to spread data symbols which can then be input to an inverse discrete Fourier transform (IDFT) block to transform the signal into the time domain. All else being equal, DFT-s-OFDM generally has lower peak-to-average power (PAPR) than OFDM. Accordingly, using DFT-s-OFDM for UL can reduce the amount of power used to transmit a given amount of data.

Within the present disclosure, a frame can refer to a duration of 10 milliseconds (ms) for wireless transmissions, with each frame including 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application can vary from the example described here, depending on any number of factors. Here, time is in the horizontal direction with units of OFDM symbols; and frequency is in the vertical direction with units of subcarriers or tones.

Resource grid 404 can be used to schematically represent time—frequency resources for a given antenna port. That is, in a MIMO implementation with multiple antenna ports available, a corresponding multiple number of resource grids 404 can be available for communication. Resource grid 404 can be divided into multiple resource elements (REs) 406. An RE, which is 1 subcarrier×1 symbol, is the smallest discrete part of the time—frequency grid, and contains a single complex value representing data from a physical channel or signal. Depending on the modulation utilized in a particular implementation, each RE can represent one or more bits of information. In some examples, a block of REs can be referred to as a physical resource block (PRB) or more simply a resource block (RB) 408, which contains any suitable number of consecutive subcarriers in the frequency domain. In one example, an RB can include 12 subcarriers, a number independent of the numerology used. In some examples, depending on the numerology, an RB can include any suitable number of consecutive OFDM symbols in the time domain. Within the present disclosure, unless otherwise stated, it is assumed that a single RB such as RB 408 entirely corresponds to a single direction of communication (either transmission or reception for a given device).

A UE generally utilizes only a subset of resource grid 404. An RB can be the smallest unit of resources that can be allocated to a UE. Thus, as more RBs are scheduled for a particular UE, the modulation scheme chosen for the air interface increases, and data rates that can be achieved by the UE also increase. In FIG. 4, RB 408 is shown as occupying less than the entire bandwidth of subframe 402, with some subcarriers illustrated above and below RB 408. In a given implementation, subframe 402 can have a bandwidth corresponding to any number of one or more RBs 408. Further, in FIG. 4, RB 408 is shown as occupying less than the entire duration of subframe 402, although this is merely one possible example.

Each subframe 402 (e.g., a 1 ms subframe) can include one or multiple adjacent slots. In the example of FIG. 4, one subframe 402 includes four slots 410, as an illustrative example. In some examples, a slot can be defined according to a specified number of OFDM symbols with a given cyclic prefix (CP) length. For example, a slot can include 7 or 14 OFDM symbols with a nominal CP. Additional examples can include mini-slots having a shorter duration (e.g., 1, 2, 4, or 7 OFDM symbols). Such mini-slots can in some cases be transmitted occupying resources scheduled for ongoing slot transmissions for the same or for different UEs.

An expanded view of one of the slots 410 illustrates slot 410 including a control region 412 and a data region 414. In general, control region 412 can carry control channels (e.g., PDCCH), and data region 414 can carry data channels (e.g., PDSCH or PUSCH). Additionally or alternatively, a slot can contain various combinations of DL and UL, such as all DL, all UL, or at least one DL portion and at least one UL portion. The simple structure illustrated in FIG. 4 is merely exemplary in nature, and different slot structures can be utilized, and can include one or more of each of the control region(s) and data region(s).

Although not illustrated in FIG. 4, various REs 406 within an RB 408 can be scheduled to carry one or more physical channels, including control channels, shared channels, data channels, etc. Other REs 406 within RB 408 can also carry pilot signals and/or reference signals. These pilot signals and/or reference signals can facilitate performance of channel estimation of the corresponding channel by a receiving device, which can enable coherent demodulation/detection of the control and/or data channels within RB 408.

In a DL transmission, the transmitting device (e.g., the base station 108) can allocate one or more REs 406 (e.g., within a control region 412) to carry DL control information (e.g., downlink control information 114 described above in connection with FIG. 1) including one or more DL control channels that generally carry information originating from higher layers, such as a physical broadcast channel (PBCH), a physical downlink control channel (PDCCH), etc., to one or more scheduled entities (e.g., a particular UE 106). In addition, DL REs can be allocated to carry DL physical signals that generally do not carry information originating from higher layers. These DL physical signals can include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, can be transmitted in an SS block that includes 4 consecutive OFDM symbols (e.g., numbered via a time index in increasing order from 0 to 3). In the frequency domain, the SS block can extend over 240 contiguous subcarriers, with the subcarriers being numbered via a frequency index in increasing order from 0 to 239. Of course, the disclosed subject matter is not limited to this specific SS block configuration. Other nonlimiting examples can utilize greater or fewer than two synchronization signals; can include one or more supplemental channels in addition to the PBCH; can omit a PBCH; and/or can utilize nonconsecutive symbols for an SS block, without departing from the scope of the present disclosure.

The PDCCH can carry downlink control information (DCI) for one or more UEs in a cell. This can include, but is not limited to, power control commands, scheduling information, a grant, and/or an assignment of REs for DL and UL transmissions.

In a UL transmission, a transmitting device (e.g., UE 106) can utilize one or more REs 406 to carry UL control information (UCI) (e.g., uplink control information 118 described above in connection with FIG. 1). The UCI can originate from higher layers via one or more UL control channels, such as a physical uplink control channel (PUCCH), a physical random access channel (PRACH), etc., to the scheduling entity (e.g., base station 108). Further, UL REs may carry UL physical signals that generally do not carry information originating from higher layers, such as demodulation reference signals (DM-RS), phase-tracking reference signals (PT-RS), sounding reference signals (SRS), etc. In some examples, the control information (e.g., uplink control information 118) can include a scheduling request (SR), i.e., a request for the scheduling entity 108 to schedule uplink transmissions. Here, in response to the SR transmitted on a control channel (e.g., over which uplink control information 118 is transmitted), the scheduling entity (e.g., base station 108) can transmit downlink control information (e.g., downlink control information 114) that can schedule resources for uplink packet transmissions.

UL control information can also include hybrid automatic repeat request (HARQ) feedback such as an acknowledgment (ACK) or negative acknowledgment (NACK), channel state information (CSI), and/or any other suitable UL control information. HARQ is a technique well-known to those of ordinary skill in the art, in which the integrity of packet transmissions can be checked at the receiving side for accuracy, e.g., utilizing any suitable integrity checking mechanism, such as a checksum or a cyclic redundancy check (CRC). If the integrity of the transmission confirmed, an ACK can be transmitted, whereas if not confirmed, a NACK can be transmitted. In response to a NACK, the transmitting device can send a HARQ retransmission, which can implement chase combining, incremental redundancy, etc.

In addition to control information, one or more REs 406 (e.g., within the data region 414) can be allocated for user data or traffic data. Such traffic can be carried on one or more traffic channels, such as, for a DL transmission, a physical downlink shared channel (PDSCH); or for an UL transmission, a physical uplink shared channel (PUSCH).

In order for a UE to gain initial access to a cell, the RAN (e.g., RAN 104, 200) can provide system information (SI) characterizing the cell. This system information can be provided utilizing minimum system information (MSI), and other system information (OSI). The MSI can be periodically broadcast over the cell to provide the most basic information required for initial cell access, and for acquiring any OSI that may be broadcast periodically or sent on-demand. In some examples, the MSI can be provided over two different downlink channels. For example, the PBCH can carry a master information block (MIB), and the PDSCH can carry a system information block type 1 (SIB1), which is sometimes referred to as the remaining minimum system information (RMSI). In a more particular example, the MIB can include parameters for monitoring a control resource set, which can provide the UE with scheduling information corresponding to the PDSCH, e.g., a resource location of SIB1.

OSI can include any SI that is not broadcast in the MSI. In some examples, the PDSCH can carry multiple SIBs, not limited to SIB1, described above. Here, the OSI can be provided in these SIBs, e.g., SIB2 and/or above.

The channels or carriers described above and illustrated in FIGS. 1 and 4 are not necessarily all the channels or carriers that can be utilized between a scheduling entity (e.g., base station 108) and scheduled entities (e.g., UEs 106), and those of ordinary skill in the art will recognize that other channels or carriers can be utilized in addition to those illustrated, such as other traffic, control, and feedback channels. These physical channels described above are generally multiplexed and mapped to transport channels for handling at the medium access control (MAC) layer. Transport channels carry blocks of information called transport blocks (TB). The transport block size (TBS), which can correspond to a number of bits of information, can be a controlled parameter, based on the modulation and coding scheme (MCS) and the number of RBs in a given transmission.

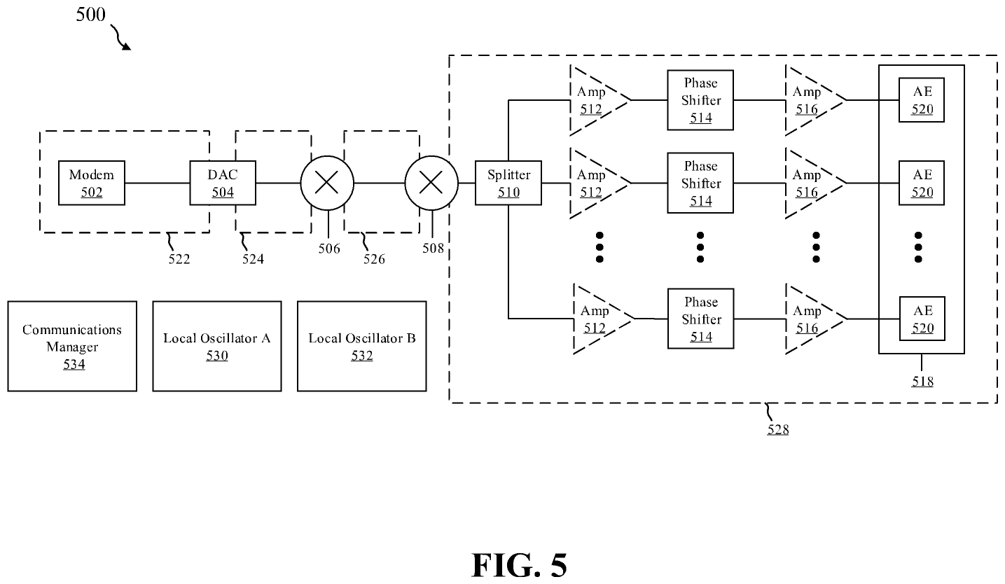

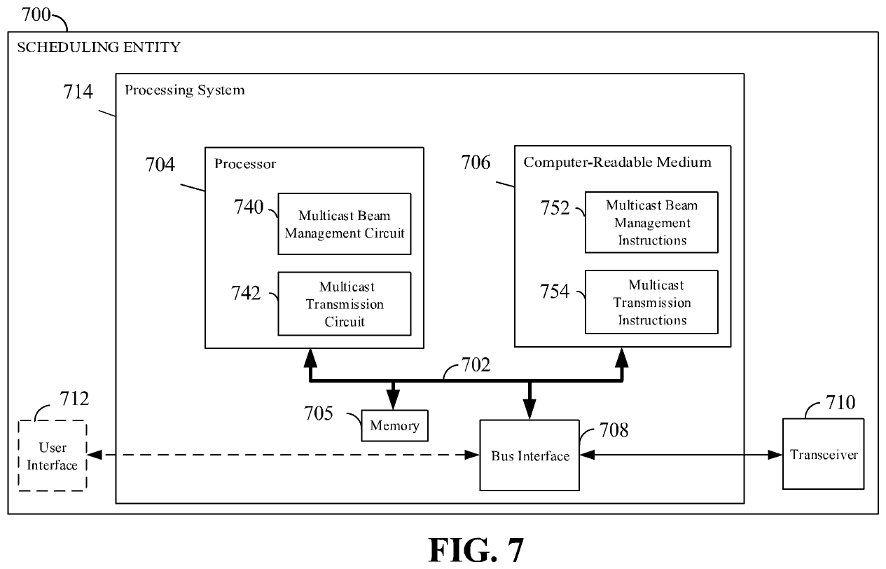

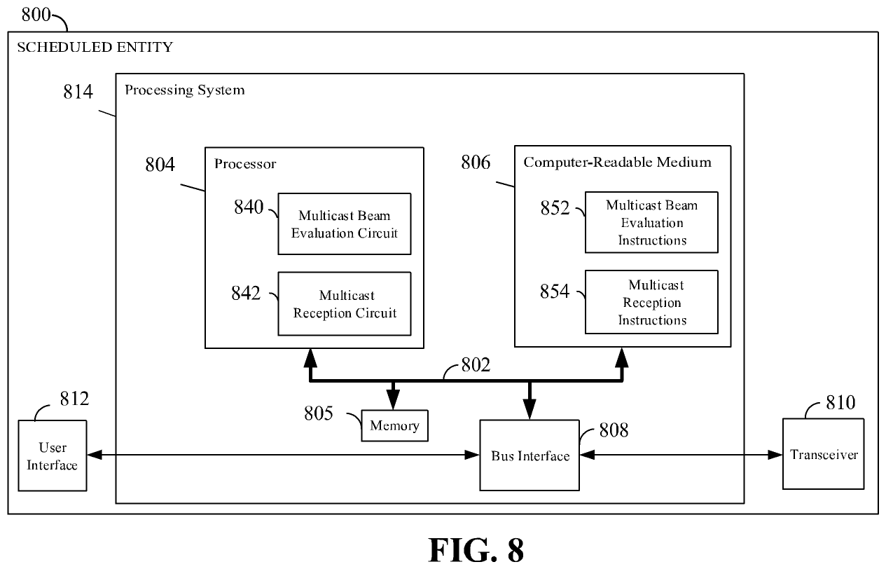

FIG. 5 is a block diagram conceptually illustrating an example of an architecture 500 that can be used to generate directed beams in accordance with some aspects of the disclosed subject matter, and is described as an illustrative example without limitation. In some aspects, architecture 500 can be used to implement aspects of any suitable device, such as a scheduling entity (e.g., as described below in connection with FIG. 7), or a scheduled entity (e.g., as described below in connection with FIG. 8). For example, in some aspects, architecture 500 can be used to implement beam forming using an antenna array of a transmitter (e.g., base station 108, transmitter 302). As another example, architecture 500 can be used to implement beam forming using an antenna array of a user equipment (e.g., UE 106). In some aspects, architecture 500 can be used to beamform transmissions to provide selective gain for a signal in a particular direction (e.g., with respect to an antenna array). For example, as described above in connection with FIG. 3, the amplitude and phase of each antenna in an array of antennas can be precoded, or otherwise controlled, to create a desired (e.g., directional) pattern of constructive and destructive interference in the wavefront.

In some aspects, architecture 500 can include components that can be used for antenna element selection, implementing phase shifting, and/or for beamforming for transmission of wireless signals. Note, however, that this is merely an example of an architecture that can be used for antenna element selection and/or for beamforming, and other suitable architectures for antenna element selection, implementing phase shifting and/or beamforming can be used in connection with the disclosed subject matter. In some aspects, architecture 500 can include a modulator/demodulator (modem) 502; a digital to analog converter (DAC) 504; a first mixer 506; a second mixer 508; a splitter 510; multiple first amplifiers 512; multiple phase shifters 514 corresponding to respective first amplifiers 512; multiple second amplifiers 516 corresponding to respective phase shifters 514; and an antenna array 518 that includes multiple antenna elements 520 corresponding to respective second amplifiers 516. In some aspects, interconnections between components of architecture 500 can be implemented using any suitable transmission lines, waveguides, wires, traces, etc., and are shown connecting the various components to illustrate how signals to be transmitted can be communicated between components. Note that architecture 500 can include components (not shown) configured to utilize antenna array 518 to receive signals. Such components can be similar to components 502-516, but configured to move an RF signal to baseband (e.g., using a combiner in lieu of splitter 510, and using additional mixers to convert frequencies received on antennas 520 down to IF from RF, and then down to baseband from IF). For example, antenna array 518 can be configured as an array of transceivers. Boxes 522, 524, 526, and 528 can indicate regions in the architecture 500 in which different types of signals are communicated and/or processed. For example, box 522 can indicate a region in which digital baseband signals are communicated and/or processed. As another example, box 524 can indicates a region in which analog baseband signals are communicated and/or processed. As yet another example, box 526 can indicate a region in which analog intermediate frequency (IF) signals are communicated and/or processed. As still another example, box 528 can indicate a region in which analog radio frequency (RF) signals are communicated and/or processed. In some aspects, architecture 500 can include a local oscillator A 530, a local oscillator B 532, and a communications manager 534.

In some aspects, each antenna element 520 can include one or more sub-elements (not shown) for radiating and/or receiving RF signals. For example, a single antenna element 520 can include a first sub-element cross-polarized with a second sub-element that can be used to independently transmit cross-polarized signals. In some aspects, antenna elements 520 can include one or more patch antennas or other types of antennas arranged in a linear array, a two dimensional array, and/or any other suitable pattern. A spacing between antenna elements 520 can be such that signals with a desired wavelength transmitted separately by antenna elements 520 can interact or interfere (e.g., to form a desired beam). For example, given an expected range of wavelengths or frequencies, the spacing can provide a quarter wavelength, half wavelength, or other fraction of a wavelength of spacing between neighboring antenna elements 520 to allow for interaction or interference of signals transmitted by separate antenna elements 520 within that expected range.

In some aspects, modem 502 can process and/or generate digital baseband signals. Additionally, in some aspects, modem 502 can control operation of DAC 504, first mixer 506, second mixer 508, splitter 510, first amplifiers 512, phase shifters 514, and/or second amplifiers 516 to transmit signals via one or more of antenna elements 520 (up to and including all antenna elements 520). For example, modem 502 can process signals and control operation in accordance with a communication standard such as a wireless standard. In some aspects, DAC 504 can convert digital baseband signals received from modem 502 for transmission into analog baseband signals. First mixer 506 can upconvert the analog baseband signals to analog IF signals within an IF using local oscillator A 530. For example, first mixer 506 can mix the analog baseband signals with an oscillating signal generated by local oscillator A 530 (e.g., generating a sinusoidal wave at the IF) to “move” the baseband analog signals to the IF. In such an example, additional processing and/or filtering (not shown) can be performed at the IF. In some aspects, second mixer 508 can upconvert the analog IF signals to analog RF signals using local oscillator B 532 (e.g., generating a sinusoidal wave at an RF carrier frequency). Similarly to first mixer 506, second mixer 508 can mix the analog IF signals with an oscillating signal generated by local oscillator B 532 to “move” the IF analog signals to the RF, or the frequency at which signals will be transmitted and/or received. In some aspects, modem 502 and/or communications manager 534 can adjust the frequency of local oscillator A 530 and/or local oscillator B 532 to produce a desired IF and/or RF frequency to facilitate processing and/or transmission of a signal within a desired bandwidth.

As shown in FIG. 5, signals upconverted by second mixer 508 can be split and/or duplicated into multiple signals by splitter 510. In some aspects, splitter 510 can split the RF signal into multiple identical or nearly identical RF signals, as denoted by its presence in box 528. Additionally or alternatively, splitting can be performed at any suitable portion of architecture 500 and/or in any suitable combination of portion of architecture 500. For example, splitter 510 can be situated within box 522 to split the digital baseband signals (e.g., between modem 502 and multiple DACs 504). As another example, splitter 510 can be situated within box 524 to split the analog baseband signals (e.g., between DAC 504 and multiple first mixers 506). As yet another example, splitter 510 can be situated within box 526 to split the IF signals (e.g., between first mixer 506 and multiple second mixers 505). In some aspects, each of the split signals can correspond to an antenna element 520, and each split signal can be communicated through, and can be processed by a first amplifier 512, a phase shifter 514, a second amplifier 516, and/or any other suitable component(s) corresponding to a respective antenna element 520 to be provided to, and transmitted by, the respective antenna element 520 of antenna array 518.

In some aspects, splitter 510 can be implemented using any suitable technique or combination of techniques. For example, splitter 510 can be an active splitter that is connected to a power supply and provides some gain such that RF signals exiting splitter 510 are higher than if a passive splitter were used (e.g., less than a 3 dB theoretical loss on each output of a 2 way splitter). In a more particular example, splitter 510 can provide enough gain to cause a power level of each output signal to be equal to or greater than the signal entering splitter 510. As another example, splitter 510 can be a passive splitter that is not connected to power supply and the RF signals exiting the splitter 510 can be at a power level lower than the RF signal entering the splitter 510 (e.g., −3 dB for a two way splitter, −4.8 dB for a three way splitter, etc.).

In some aspects, RF signals (e.g., output by splitter 510, or one of multiple second mixers 508 if splitter 510 is located upstream of box 528) can enter an amplifier, such as first amplifier 512, or a phase shifter, such as phase shifter 514, corresponding to a particular antenna element 520. Note that, in some implementations, first amplifiers 512 and/or second amplifiers 516 can be omitted, as gain may not be required. For example, first amplifiers 512 and second amplifiers 516 can both be included in architecture 500. As another example, both first amplifiers 512 and second amplifiers 516 can be omitted (e.g., box 528 can omit all amplifiers, including, in some cases, any amplification provided by splitter 510). In a more particular example, if splitter 510 is an active splitter, first amplifiers 512 can be omitted. As another example, if phase shifter 514 is an active phase shifter that provides a gain, second amplifiers 516 can be omitted. In some aspects, first amplifiers 512 and/or second amplifiers 516 can provide a desired level of positive or negative gain. A positive gain (positive dB) can be used to increase an amplitude of a signal for radiation by a specific antenna element 520. A negative gain (negative dB) can be used to decrease an amplitude and/or suppress radiation of the signal provided to a specific antenna element 520. In some aspects, each individual amplifier (e.g., each first amplifier 512 and/or each second amplifier 516) can be controlled independently (e.g., by the modem 502 and/or communications manager 534) to provide independent control of the gain for each antenna element 520. For example, modem 502 and/or the communications manager 534 can be operatively coupled, via a control line, to various components (e.g., one or more of splitter 510, first amplifiers 512, phase shifters 514, and/or second amplifiers 516), and can provide control signals that can be used to configure a gain provided by one or more of the components to provide a desired amount of gain to signals communicated to each antenna element 520.

In some aspects, phase shifter 514 can provide a configurable phase shift (which can also be referred to as a phase offset) to a corresponding RF signal to be transmitted. In some aspects, phase shifter 514 can be implemented using any suitable technique or combination of techniques. For example, phase shifter 514 can be a passive phase shifter that is not directly connected to a power supply. In such an example, phase shifter 514 may introduce some insertion loss. In such an example, second amplifiers 516 can provide sufficient gain to a signal output from phase shifter 514 to at least compensate for the insertion loss. As another example, phase shifter 514 can be an active phase shifter connected to a power supply such that the active phase shifter provides some amount of gain and/or prevents insertion loss. As described above, in such an example, second amplifiers 516 may or may not be omitted. In some aspects, settings of each of phase shifter 514 can be controlled independently (e.g., by the modem 502 and/or communications manager 534) such that each phase shifter 514 can be set to provide a particular desired amount of phase shift, which may or may not be the same amount of phase shift provided by a different phase shifter 514. In some aspects, modem 502 and/or the communications manager 534 can be operatively coupled, via a control line, to phase shifters 514 and which may be used to configure the phase shifters 514, and can provide control signals that can be used to configure a desired amount of phase shift between one or more of antenna elements 520.

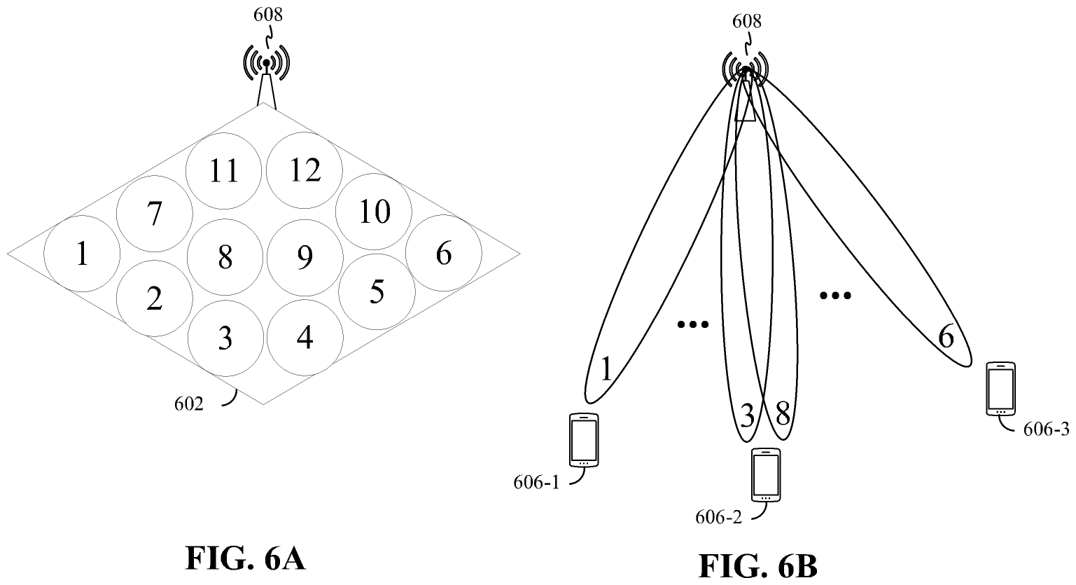

FIGS. 6A and 6B are schematic illustrations of beam indices associated with various portions of a cell, and beam indices of various beams that can be used to transmit one or more multicast sessions based on reports from various reduced capability user equipments, respectively, in accordance with some aspects of the disclosed subject matter. As shown in FIG. 6A, a portion 602 of a cell (e.g., a sector) corresponding to a particular base station 608 can be covered by any suitable number of beams, which can each be associated with a beam index. In the example shown in FIG. 6A, sector 602 is covered by twelve beams with indices from 1 to 12. In such an example, each beam index can be associated with a particular precoded combination of amplitude and phase for each antenna in an array of antennas (e.g., antenna elements 520 of antenna array 518) that can cause a beam directed to the portion of sector 602 associated with that beam index. Note that FIG. 6A is merely an example to illustrate concepts that can be used in connection with some aspects of the disclosed subject matter, and a sector or other portion of a cell can be associated with any suitable number of beams, which may or may not be substantially identical in size. For example, different beams can cover differently sized areas of sector 602. As another example, although FIG. 6A shows the beams as covering mutually exclusive areas of sector 602, different beams can cover overlapping portions of sector 602. In a particular example, beams corresponding to indices 2, 3, and 8 can all cover the portion located between the circles representing those beams in FIG. 6A.

As shown in FIG. 6B, various UEs 606 (which can be, e.g., RedCap UEs) can be located within an area covered by one or more beams that can be formed by base station 608. For example, UE 606-1 is located within an area covered by beam 1, UE 606-2 is located within an area covered by beams 3 and 8, and UE 606-3 is located within an area covered by beam 6.

FIG. 7 is a block diagram conceptually illustrating an example of a hardware implementation for a scheduling entity 700 in accordance with some aspects of the disclosed subject matter, and is described as an illustrative example without limitation. For example, scheduling entity 700 can be a user equipment (UE) as illustrated in any one or more of FIGS. 1, 2, and/or 3. In another example, scheduling entity 700 can be a base station as illustrated in any one or more of FIGS. 1, 2, and/or 3.

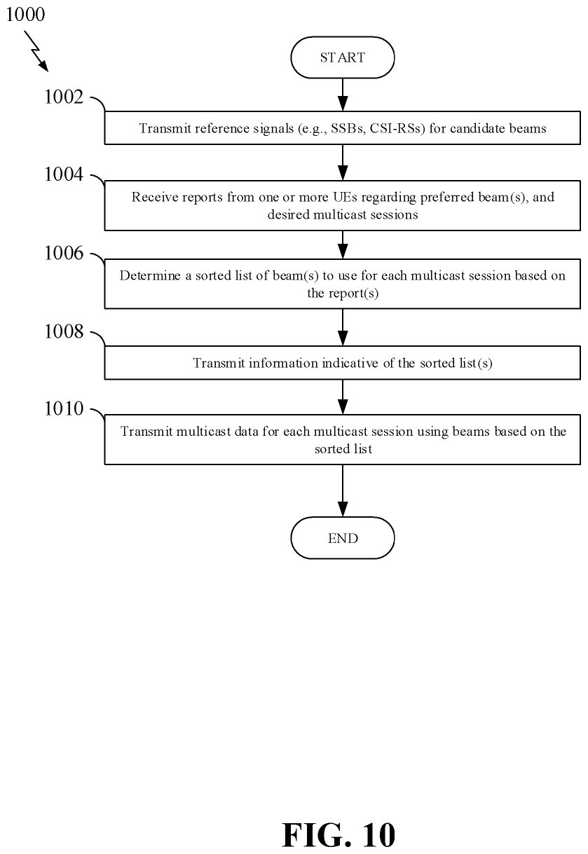

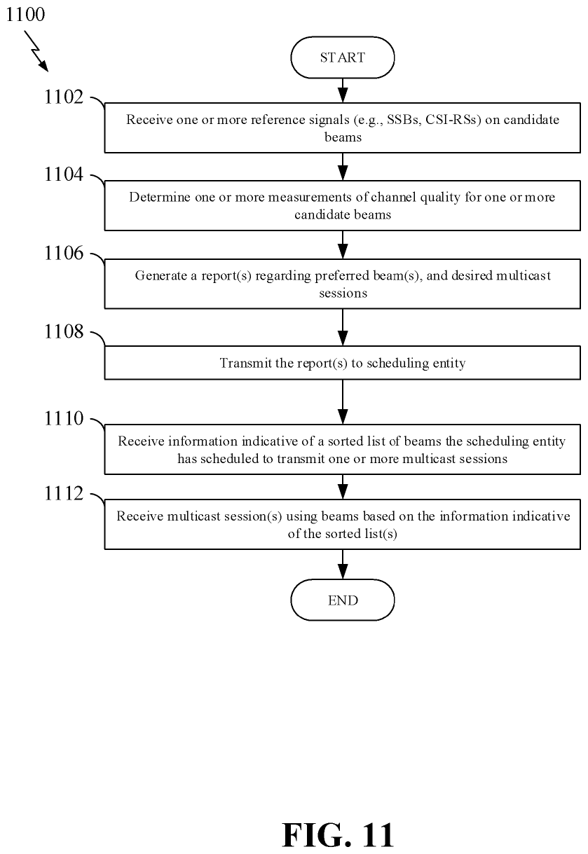

In some aspects, scheduling entity 700 can be implemented with a processing system 714 that includes one or more processors 704. Examples of processors 704 include central processing units (CPUs), microprocessors, microcontrollers, digital signal processors (DSPs), field programmable gate arrays (FPGAs), programmable logic devices (PLDs), graphics processing units (GPUs), state machines, gated logic, discrete hardware circuits, and other suitable hardware configured to perform the various functionality described throughout this disclosure. In various examples, scheduling entity 700 can be configured to perform any one or more of the functions described herein. That is, processor 704, as utilized in scheduling entity 700, can be used to implement any one or more of the processes and procedures described below in connection with FIGS. 10 and 11.

In this example, processing system 714 can be implemented with a bus architecture, represented generally by the bus 702. Bus 702 can include any number of interconnecting buses and bridges depending on the specific application of processing system 714 and the overall design constraints. Bus 702 can communicatively couple together various circuits including one or more processors (represented generally by processor 704), memory 705, and computer-readable media (represented generally by computer-readable medium 706). Bus 702 can also link various other circuits such as timing sources, peripherals, voltage regulators, and power management circuits, which are well known in the art, and therefore, will not be described any further. A bus interface 708 can provide an interface between bus 702 and a transceiver 710. Transceiver 710 can provide a communication interface or means for communicating with various other apparatus over a transmission medium. In some aspects, transceiver 710 can be configured using an array of antennas (e.g., antenna array 518) to facilitate directional transmission and/or reception as described above in connection with FIG. 5. Depending upon the nature of the apparatus, a user interface 712 (e.g., keypad, display, speaker, microphone, joystick) can also be provided. Of course, such a user interface 712 can be omitted in some examples, such as a base station.

In some aspects of the disclosed subject matter, processor 704 can include multicast beam management circuitry 740 configured for various functions, including, for example, receiving, via a transceiver (e.g., transceiver 710), reports from various UEs (e.g., RedCap UEs) regarding beam channel quality information, receiving, via a transceiver (e.g., transceiver 710), information from various UEs regarding beam preference information, and/or determining a sorted list of beams to use for various multicast sessions based on quality and/or preference information received from the various UEs. For example, multicast beam management circuitry 740 can be configured to implement one or more of the functions described below in connection with FIG. 10, such as functions described in connection with 1004, 1006, and/or 1008. Additionally, in some aspects, processor 704 can include multicast transmission circuitry 742 configured for various functions, including, for example, causing an array of antennas (e.g., transceiver 710) to transmit reference signals on various beams that can be used to transmit multicast data associated with various multicast sessions (e.g., to RedCap UEs), causing an array of antennas (e.g., transceiver 710) to transmit multicast data associated with various multicast sessions using radio resources determined based on the sorted list(s) of beams. For example, multicast transmission circuitry 742 can be configured to implement one or more of the functions described below in connection with FIG. 10, such as functions described in connection with 1002 and/or 1010.

Processor 704 can manage bus 702 and can perform general processing, including the execution of software stored on computer-readable medium 706, which, when executed by processor 704, causes processing system 714 to perform the various functions described below (e.g., in connection with FIGS. 10 and 11) for any particular apparatus. In some aspects, computer-readable medium 706 and memory 705 can also be used for storing data that is manipulated by processor 704 when executing software.

One or more processors 704 in the processing system can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software can reside on a computer-readable medium 706. The computer-readable medium 706 can be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that can be accessed and read by a computer. The computer-readable medium 706 can reside in the processing system 714, external to the processing system 714, or distributed across multiple entities including the processing system 714. The computer-readable medium 706 can be embodied in a computer program product. By way of example, a computer program product can include a computer-readable medium in packaging materials. Those skilled in the art will recognize how best to implement the described functionality presented throughout this disclosure depending on the particular application and the overall design constraints imposed on the overall system.

In one or more examples, computer-readable storage medium 706 can multicast beam management software 752 configured for various functions, including, for example, receiving, via a transceiver (e.g., transceiver 710), reports from various UEs (e.g., RedCap UEs) regarding beam channel quality information, receiving, via a transceiver (e.g., transceiver 710), information from various UEs regarding beam preference information, and/or determining a sorted list of beams to use for various multicast sessions based on quality and/or preference information received from the various UEs. For example, multicast beam management software 752 can be configured to implement one or more of the functions described below in connection with FIG. 10, such as functions described in connection with 1004, 1006, and/or 1008. Additionally, in some aspects, computer-readable storage medium 706 can include multicast transmission software 754 configured for various functions, including, for example, causing an array of antennas (e.g., transceiver 710) to transmit reference signals on various beams that can be used to transmit multicast data associated with various multicast sessions (e.g., to RedCap UEs), causing an array of antennas (e.g., transceiver 710) to transmit multicast data associated with various multicast sessions using radio resources determined based on the sorted list(s) of beams. For example, multicast transmission software 754 can be configured to implement one or more of the functions described below in connection with FIG. 10, such as functions described in connection with 1002 and/or 1010.

In some aspects, scheduling entity 700 can include means for transmitting, to various UEs, a list of at least one beam of multiple beams associated with a multicast session(s) that the one or more UEs are interested in accessing, means for determining beams to include in the list of beams based on information indicating that which beam(s) is preferred by the one or more UEs, and/or means for transmitting multicast data associated with the multicast session(s) using a beam from the list. In some aspects, the aforementioned means can be the processor(s) 704 shown in FIG. 7 configured to perform the functions recited by the aforementioned means. In another aspect, the aforementioned means can be a circuit or any apparatus configured to perform the functions recited by the aforementioned means.

Of course, in the above examples, the circuitry included in the processor 704 is merely provided as an example, and other means for carrying out the described functions can be included within various aspects of the present disclosure, including but not limited to the instructions stored in the computer-readable storage medium 706, or any other suitable apparatus or means described in any one of the FIGS. 1, 2, and/or 3, and utilizing, for example, the processes and/or algorithms described below in connection with FIGS. 10 and/or 11.

FIG. 8 is a block diagram conceptually illustrating an example of a hardware implementation for a scheduled entity 800 in accordance with some aspects of the disclosed subject matter, and is described as an illustrative example without limitation. For example, scheduled entity 800 can be a user equipment (UE) as illustrated in any one or more of FIGS. 1, 2, and/or 3. In accordance with some aspects of the disclosure, an element, or any portion of an element, or any combination of elements can be implemented with a processing system 814 that includes one or more processors 804.

In some aspects, processing system 814 can be substantially the same as the processing system 814 illustrated in FIG. 8, including a bus interface 808, a bus 802, memory 805, processor 804, and a computer-readable medium 806. Furthermore, scheduled entity 800 can include a user interface 810 and a transceiver 810 substantially similar to those described above in FIG. 8. That is, processor 804, as utilized in a scheduled entity 800, can be used to implement any one or more of the processes described below in connection with, and illustrated in, FIG. 11.

In some aspects of the disclosure, processor 804 can include multicast beam evaluation circuit circuitry 840 configured for various functions, including, for example, determining measurements of channel quality for one or more candidate beams, generating a report(s) regarding the channel quality of the one or more candidate beams and/or beam preference information, and/or causing the report(s) to be transmitted (e.g. via transceiver 810) to a scheduling entity (e.g., scheduling entity 700). For example, multicast beam evaluation circuit circuitry 840 can be configured to implement one or more of the functions described below in connection with FIG. 11, such as functions described in connection with one or more of 1104, 1106, and/or 1108. Additionally, in some aspects, processor 804 can include multicast reception circuitry 842 configured for various functions, including, for example, receiving, via a transceiver (e.g., transceiver 810), one or more reference signals transmitted on candidate beams, receiving, via a transceiver (e.g., transceiver 810), information indicative of a sorted list of beams to use to receive multicast data associated with one or more multicast sessions, and/or receive, via a transceiver (e.g., transceiver 810), multicast data using a beam from the sorted list of beams. For example, multicast reception circuitry 842 can be configured to implement one or more of the functions described below in connection with FIG. 11, such as functions described in connection with one or more of 1102, 1110, and/or 1112.

In one or more examples, computer-readable storage medium 806 can include multicast beam evaluation circuit software 852 configured for various functions, including, for example, determining measurements of channel quality for one or more candidate beams, generating a report(s) regarding the channel quality of the one or more candidate beams and/or beam preference information, and/or causing the report(s) to be transmitted (e.g. via transceiver 810) to a scheduling entity (e.g., scheduling entity 700). For example, multicast beam evaluation circuit software 852 can be configured to implement one or more of the functions described below in connection with FIG. 11, such as functions described in connection with one or more of 1104, 1106, and/or 1108. Additionally, in some aspects, computer-readable storage medium 806 can include multicast reception software 854 configured for various functions, including, for example, receiving, via a transceiver (e.g., transceiver 810), one or more reference signals transmitted on candidate beams, receiving, via a transceiver (e.g., transceiver 810), information indicative of a sorted list of beams to use to receive multicast data associated with one or more multicast sessions, and/or receive, via a transceiver (e.g., transceiver 810), multicast data using a beam from the sorted list of beams. For example, multicast reception software 854 can be configured to implement one or more of the functions described below in connection with FIG. 11, such as functions described in connection with one or more of 1102, 1110, and/or 1112.

In some aspects, scheduled entity 800 can include means for estimating channel quality of one or more candidate beams, means for receiving, from a scheduling entity (e.g., a base station), a list of at least one beam of multiple beams associated with a multicast session(s) that scheduled entity 800 is interested in accessing, and/or means for receiving multicast data associated with the multicast session(s) using a beam from the list. In some aspects, the aforementioned means can be the processor(s) 804 shown in FIG. 8 configured to perform the functions recited by the aforementioned means. In another aspect, the aforementioned means can be a circuit or any apparatus configured to perform the functions recited by the aforementioned means.

Of course, in the above examples, the circuitry included in the processor 804 is merely provided as an example, and other means for carrying out the described functions can be included within various aspects of the present disclosure, including but not limited to the instructions stored in the computer-readable storage medium 806, or any other suitable apparatus or means described in any one of the FIGS. 1, 2, and/or 3, and utilizing, for example, the processes and/or algorithms described below in connection with FIGS. 10 and/or 11.

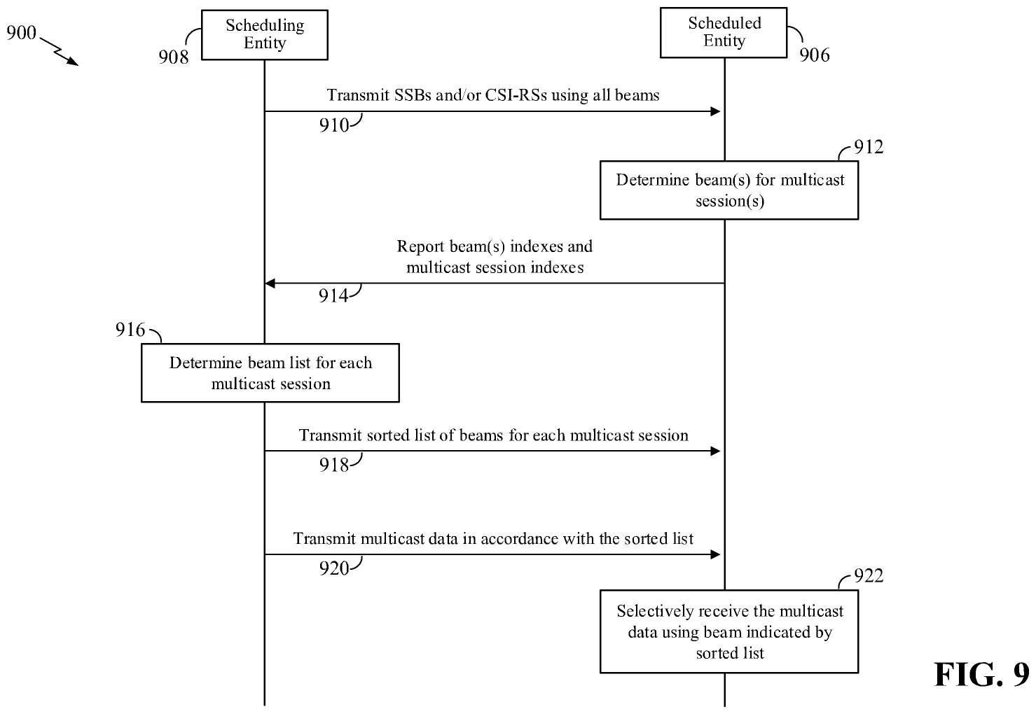

FIG. 9 is a signaling diagram illustrating exemplary signaling between a scheduling entity 908 and a scheduled entity 906 within a wireless communication system 900 to schedule and transmit multicast data on one or more preferred beams of RedCap UEs in accordance with some aspects of the disclosed subject matter, and is described as an illustrative example without limitation. In some aspects, wireless communication system 900 can correspond, for example, to a portion of wireless communication system 100 described above in connection with, and shown in, FIG. 1.

In some aspects, scheduling entity 908 can correspond, for example, to a base station (e.g., a gNB or eNB, base station 108, base station 608, etc.) or other scheduling entity described above in connection with FIGS. 1 and/or 2. In some aspects, scheduled entity 906 can correspond, for example, to a UE (e.g., UE 106, UE 602, etc.) or other scheduled node as described above in connection with FIGS. 1 and/or 2. In some aspects, scheduled entity 906 can be a RedCap UE.

At 910, scheduling entity 908 can periodically (e.g., at regular and/or irregular intervals) transmit synchronization signal blocks (SSBs) and/or channel state information reference signals (CSI-RSs) using various beams that can be used to transmit multicast data associated with one or more multicast sessions. For example, scheduling entity 908 can transmit SSBs and/or CSI-RSs using every beam available for transmission of multicast data. In a particular example, scheduling entity 908 can use a beam sweeping technique to periodically (e.g., at regular and/or irregular intervals) transmit SSBs and/or CSI-RSs using every beam available for transmission of multicast data in a particular portion of a cell (e.g., a particular sector as described above in connection with FIG. 6A).

In some aspects, scheduling entity 908 can use any suitable technique or combination of techniques to transmit SSBs and/or CSI-RSs. For example, scheduling entity 908 can transmit the SSBs and/or CSI-RSs using any suitable communication network (e.g., via a RAN, such as RAN 104 or RAN 200, using one or more DL slots, etc.). In some aspects, scheduling entity 908 can transmit the SSBs and/or CSI-RSs using any suitable communication interface, such as a transceiver (e.g., transceiver 710). As described above, in some aspects, scheduling entity 908 can use beam sweeping techniques to transmit SSBs and/or CSI-RSs using beams that can be used to transmit multicast data.

At 912, scheduled entity 906 can receive one or more SSBs and/or CSI-RSs transmitted by scheduling entity 910, and can measure channel quality using the one or more SSBs and/or CSI-RSs. In some aspects, scheduled entity 906 can select one or more beams as beams that scheduling entity 910 can use to receive multicast data. For example, as described above in connection with FIG. 3, scheduled entity 906 can estimate one or more parameters using each received SSB and/or CSI-RS. For example, scheduled entity 906 can estimate one or more reference signal received power (RSRP) parameters (e.g., primary synchronization signal (PSS)-RSRP, secondary synchronization signal (SSS)-RSRP, physical broadcast channel (PBCH)-RSRP, CSI-RSRP, etc.). As another example, scheduled entity 906 can estimate one or more reference signal received quality (RSRQ) parameters (e.g., PSS-RSRQ, SSS-RSRQ, PBCH-RSRQ, CSI-RSRQ, etc.). As yet another example, scheduled entity 906 can estimate one or more signal-to-interference-and-noise ratio (SINR) parameters (e.g., PSS-SINR, SSS-SINR, CSI-SINR). As still another example, scheduled entity 906 can estimate a rank indicator (RI) parameter, a precoding matrix indicator (PMI) parameter, a channel quality indicator (CQI) parameter, a layer indicator (LI), etc., based on each received CSI-RS. In some aspects, scheduled entity 906 can use any suitable technique or combination of techniques to receive the one or more SSBs and/or CSI-RSs. For example, scheduled entity 906 can sample and buffer a received wireless signal comprising an SSB or a CSI-RS, and apply suitable processing to the buffered signal such as energy detection, demodulation, decoding, etc. In some aspects, scheduled entity 906 can receive the one or more SSBs and/or CSI-RSs using any suitable communication interface, such as a transceiver (e.g., transceiver 810).

In some aspects, scheduled entity 906 can determine one or more preferred beams for receiving multicast data based on one or more parameters estimated using the SSB and/or CSI-RS associated with each beam. For example, scheduled entity 906 can select a predetermined number of beams (e.g., one, two, three, etc.) that cover scheduled entity 906 (e.g., based on one or more parameters derived from the SSB and/or CSI-RS associated with a particular beam that are indicative of quality). In a more particular example, scheduled entity 906 can select a predetermined number of beams based on an SINR (or any other suitable parameter indicative of channel quality) associated with each beam. For example, scheduled entity 906 can select all beams that have a quality parameter that satisfies a threshold. In a more particular example, scheduled entity 906 can select all beams associated with an SINR (or any other suitable parameter indicative of channel quality) value that is at least a threshold value. In some aspects, scheduled entity 906 can omit explicitly selecting one or more beams, and can report quality information to scheduling entity 908, which can determine which beams are best for scheduled entity 906.

In some aspects, scheduled entity 906 can generate a report (e.g., a CSI report) that includes any suitable quality information for one or more beams received by scheduled entity 906.

At 914, scheduled entity 906 can transmit information indicative of one or more beams that scheduled entity 906 can use to receive multicast data (e.g., the report generated at 912). Additionally, in some aspects, scheduled entity 906 can transmit information indicative of which multicast session or sessions scheduled entity 906 is interested in accessing.

In some aspects, the information indicative of one or more beams that scheduled entity 906 can use to receive multicast data can be explicit information identifying one or more beams (e.g., by SSB beam index, CSI-RS beam index, etc.) that scheduled entity 906 has determined are suitable for receiving multicast data from scheduling entity 908. Additionally or alternatively, in some aspects, the information indicative of one or more beams that scheduling entity 906 can use to receive multicast data can be implicit information indicative of one or more suitable beams, such as quality information associated with one or more beams (e.g., by SSB beam index, CSI-RS beam index, etc.).

In some aspects, the information indicative of one or more beams that scheduling entity 906 can use to receive multicast data can include quasi co-location (QCL) information associated with each of the beams. For example, such QCL information can identify properties of an antenna port that transmitted the beam. In a particular example, two channels can have a QCL relationship when properties of a channel over which a symbol on one antenna port is conveyed can be inferred from a channel over which a symbol on another antenna port is conveyed. For example, if signal A is quasi co-located (QCL'ed) to signal B, then signal A has gone through the similar channel condition as signal B. The channel information estimated to detect signal A can also help detect signal B. Numerous factors can define the channel condition. Current 3GPP descriptions of such channel condition can include Doppler shift, Doppler spread, average delay, delay spread, and/or spatial reception (Rx) parameter. One or more of these factors can form a property of the channel that two signals share. Currently, predefined groups of these factors can be labeled as QCL types. For example, Type-A includes Doppler shift, Doppler spread, average delay, and delay spread. Type-B includes Doppler shift and Doppler spread. Type-C includes average delay and Doppler shift. Type-D includes spatial Rx parameter. In a more particular example, signal A is QCL'ed with signal B by type-D when signal A and signal B are transmitted on a similar radio channel that shares similar properties in terms of spatial Rx parameter.

In some aspects, scheduled entity 906 can transmit the information indicative of one or more beams that scheduled entity 906 can use to receive multicast data as a report, such as a CSI report (e.g., a CSI report for multicast).

In some aspects, the minimum and/or maximum number of beams included in the information indicative of one or more beams that scheduled entity 906 can use to receive multicast data can be predetermined. For example, a communication standard (e.g., a 3GPP standard) can specify a minimum and/or maximum number of beams to be included in the information indicative of one or more beams that scheduled entity 906 can use to receive multicast data. As another example, scheduling entity 908 can specify a minimum and/or maximum number of beams to be included in the information indicative of one or more beams that scheduled entity 906 can use to receive multicast data. As yet another example, a communication standard (e.g., a 3GPP standard) can specify a range of a number of beams that can be included in the information indicative of one or more beams that scheduled entity 906 can use to receive multicast data, and scheduling entity 908 can specify a minimum and/or maximum number of beams within the range specified by the communication standard.

In some aspects, scheduled entity 906 can use any suitable technique or combination of techniques to transmit the information indicative of one or more beams that scheduled entity 906 can use to receive multicast data. For example, scheduled entity 906 can transmit the information indicative of one or more beams that scheduled entity 906 can use to receive multicast data using any suitable communication network (e.g., via a RAN, such as RAN 104 or RAN 200, using one or more DL slots, etc.). As another example, scheduled entity 906 can transmit the information indicative of one or more beams that scheduled entity 906 can use to receive multicast data using any suitable signaling, such as via an RRC message, a MAC control element (CE), uplink control information (UCI), and/or any other suitable signaling. In some aspects, scheduled entity 906 can transmit the information indicative of one or more beams that scheduled entity 906 can use to receive multicast data using any suitable communication interface, such as a transceiver (e.g., transceiver 810).

In some aspects, scheduling entity 908 can use any suitable technique or combination of techniques to receive the information indicative of one or more beams that scheduled entity 906 can use to receive multicast data and/or information indicative of which multicast session or sessions scheduled entity 906 is interested in accessing. In some aspects, scheduling entity 908 can use any suitable technique or combination of techniques to receive the information transmitted by scheduled entity 906 at 914. For example, scheduling entity 908 can sample and buffer a received wireless signal encoded with the information, and apply suitable processing to the buffered signal such as energy detection, demodulation, decoding, etc. In some aspects, scheduling entity 908 can receive the information indicative of one or more beams that scheduled entity 906 can use to receive multicast data using any suitable communication interface, such as a transceiver (e.g., transceiver 710).

In some aspects, scheduling entity 908 can receive information transmitted by multiple scheduled entities within a cell or portion of a cell covered by scheduling entity. For example, each scheduled entity that is interested in accessing at least one multicast session can transmit information indicative of one or more beams that the scheduled entity can use to receive multicast data and/or information indicative of which multicast session or sessions that the scheduled entity is interested in accessing. In some aspects, only certain types of scheduled entities (e.g., only RedCap UEs; only RedCap UEs and eMBB UEs; only RedCap UEs, eMBB UEs, and URLLC UEs, etc.) can transmit such information. Alternatively, in some aspects, each scheduled entity that is interested in accessing at least one multicast session, regardless of the type of scheduled device, can be required to transmit information indicative of one or more beams that the scheduled entity can use to receive multicast data and/or information indicative of which multicast session or sessions that the scheduled entity is interested in accessing.

At 916, scheduling entity 908 can determine which beam or beams to use to transmit various multicast sessions (e.g., multicast sessions that at least one scheduled entity is interested in accessing). In some aspects, scheduling entity 908 can use the information indicative of one or more beams that scheduled entities (e.g., scheduled entity 906 and other scheduled entities) can use to receive multicast data to determine which beam or beams to use to transmit multicast sessions.

For example, scheduling entity 908 can determine, for each multicast session, a minimum number of beams that can be used to cover all of the UEs that are interested in accessing that multicast session. Table 1 shows an example of beams that various scheduled entities (e.g., UEs) can use to receive multicast sessions, and multicast sessions that the scheduled entities are interested in accessing.

TABLE 1

| | Multicast Session 1 | Multicast Session 2 | Multicast Session 3 |
|---|---|---|---|
| UE 1 | Beam 1 | Beam 1 | |
| UE 2 | Beam 2 | | Beam 2 |
| UE 3 | Beams 1 and 3 | | Beams 1 and 3 |

In the simple example in Table 1, scheduling entity can determine that all UEs interested in multicast session 1 can be covered by beams 1 and 2, all UEs interested in multicast session 2 can be covered by beam 1, and all UEs interested in multicast session 3 can be covered by beams 1 and 2.

As described above in connection with 914, in some aspects, information indicative of one or more beams that scheduled entity 906 can use to receive multicast data can be explicit information identifying one or more beams (e.g., by SSB beam index, CSI-RS beam index, etc.) that scheduled entity 906 has determined are suitable for receiving multicast data from scheduling entity 908. Additionally or alternatively, in some aspects, the information indicative of one or more beams that scheduling entity 906 can use to receive multicast data can be implicit information indicative of one or more suitable beams, such as quality information associated with one or more beams (e.g., by SSB beam index, CSI-RS beam index, etc.). Regardless of whether the information indicative of one or more beams that scheduled entity 906 can use to receive multicast data is explicit, in some aspects, scheduling entity 908 can independently determine whether a particular beam can cover a UE for a particular multicast session. For example, scheduling entity 908 can derive a physical layer SINR threshold, and can compare a physical layer SINR value reported by each scheduled entity for each beam to the threshold. If the value for a particular beam meets the physical layer SINR threshold (e.g., if the physical layer SINR value is greater than the physical layer SINR threshold, or if the physical layer SINR value is greater than or equal to the physical layer SINR threshold), scheduling entity 908 can determine that the scheduled entity is covered by that beam.

In some aspects, scheduling entity 908 can sort the beams for each multicast session to generate a sorted list based on beam indexes. Additionally, in some aspects, if the transmission beams associated with multiple multicast sessions overlap, the beam lists associated with those multicast sessions can be combined. For example, Table 1 above, multicast sessions 1 and 3 can be transmitted using beams 1 and 2 to cover UE 1 and UE 2 (e.g., if beam 1 or beam 2 is omitted, UE1 or UE2 may be unable to access multicast session 1), while these two sessions can be transmitted on either beam 1 or beam 3 to cover UE 3. Accordingly, because these two multicast sessions have a list with overlapping entries, the two multicast sessions can be combined to determine which beams to use to cover the UEs interested in accessing those multicast sessions. In such an example, beams 1 and 2 can be used to transmit both multicast sessions 1 and 3, because those beams can cover all of the UEs interested in accessing those multicast sessions. Table 2 shows an example representation of sorted beam lists that can be generated to cover the UEs in Table 1.

TABLE 2

| | Multicast | Multicast | Multicast |
|---|---|---|---|
| | Session 1 | Session 2 | Session 3 |
| Sorted Beam List | Beams 1, 2 | Beam 1 | Beams 1, 2 |

In some aspects, scheduling entity 908 can format the sorted lists associated with each multicast session using any suitable technique or combination of techniques. For example, the list can be expressed as explicit beam indexes (e.g., represented using any suitable number of bits). As another example, the list can be expressed using a value cᵢϵCₘⁿ, that represents a unique combination of n selected beams from a full set of m possible multicast beams, where n≤m, and Cₙ^{m}, can represent a set of N integers that each correspond to a particular unique combination of combinations where 1≤i≤N. In such an example, each combination of n beams from the set of m beams can be associated with an integer value such that given m and n the value of cᵢ identifies one subset of n beams from the set of m beams. In a particular example, if there are m=16 possible beams, and n=6 beams are selected, a particular value of cᵢϵC₁₆⁶ (which can be represented using the notation C₁₆⁶(i)) can correspond to a particular 6-combination of beams from all possible 6-combinations that can be drawn from the set of 16 possible beams (e.g., indexed using values 1-16 or 0-15). In such an example, index C₁₆⁶ can include 8,008 index values each corresponding to one of the 8,008 possible combinations of 6 beams that can be drawn from the 16 total beams (i.e., (₆¹⁶) or “16 choose 6” has 8,008 unique combinations), and each index value 1 to 8,008 (or 0 to 8,007) can be paired with a unique combination of 6 beams. In a particular example, C₁₆⁶(1) can correspond to the subset of beams {1, 2, 3, 4, 5, 6}, C₁₆⁶(2) can correspond to the subset of beams {1, 2, 3, 4, 5, 7}, and so on, with C₁₆⁶(8008) corresponding to the subset of beams {11, 12, 13, 14, 15, 16}.

As another more particular example, if there are 4 possible multicast beams, but only two of the four beams are selected, there are only 6 possible combinations of 2 beams (e.g., {1, 2}, {1, 3}, {1, 4}, {2, 3}, {2, 4}, {3, 4}). Using the notation described above, an index C₄² can include 6 index values each corresponding to a particular combination of two beams. In such an example, given the total number of selectable beams m, and the number of selected beams n, the possible combinations of n selected beams of the m selectable beams can be determined and those combinations can be mapped to index C₄² including six index values corresponding to the six possible combinations (e.g., from 0-5 or 1-6). All of the index values associated with C₄² can be represented using 3 bits. In such an example, the number of selected beams n can be represented using 3 bits or 2 bits if binary “00” represents a decimal 1 rather a decimal 0, which can allow any value of n up to m (e.g., n=2 can be represented as “010” or “01”). Alternatively, because the number of selected beams n is 2 in the current example, n can be represented using only 2 bits or 1 bit if binary “0” represents a decimal 1 rather a decimal 0 (e.g., n=2 can be represented as “10” or “1”). In such an example, the number of bits used to represent n can be set based on the minimum number of bits required to represent the current value of n, rather than the number of bits required to represent all possible values of n (e.g., up to m).

Extending the current example, if the sorted list of selected beams is set to include two beams of four possible selectable beams (i.e., n=2 and m=4), then there are only 6 possible combinations that include two beams of the 16 total combinations, which can be represented using only 3 bits as described above. Accordingly, in some aspects, the number of bits used to represent a sorted list of selected beams (e.g., a particular combination of selected beams) can depend on various factors. For example, the number of bits used to represent the number of selected beams n can depend on whether the number of bits is selected to allow any value of n up to the maximum number of selectable beams m, or to use only the number of bits required to represent the current value of n. As another example, the number of bits used to represent the index value that corresponds to the particular combination of beams that are selected can depend on whether the index represents only combinations of n selected beams of the m selectable beams, or a particular combination from all possible combinations of the m selectable beams (e.g., for four beams, an index Cₘ can represent every combination of beams for 0≤n≤16 or 1≤n≤16 if the empty set is excluded).

Extending the examples described above, if n=2 and m=4, and beams 1 and 2 are the selected beams, an indication that beams 1 and 2 (e.g., the combination {1, 2}) are selected can be represented using various numbers of bits. As shown below in Table 3, the combination {1, 2} can be represented at least four ways. In Table 3,

TABLE 3

| | Selected Beams | | |
|---|---|---|---|
| Index Size | [log₂ 4] bits | [log₂ 2] bits | 0 bits |
| [log₂ \|C₄²\|] bits | 010001 | 10001 | NA |
| [log₂ \|C₄\|] bits | 0100110 | 100110 | 0110 |

In Table 3, |C₄²| represents the cardinality of the index (e.g., the number of index values in the set). The underlined bits represent n, and the non-underlined bits represent the index corresponding to the combination {1, 2}. For example, index C₄² has 6 index values corresponding to the 6 possible combinations of 2 beams from the set of 4 possible beams, and these 6 combinations can be represented using three bits (if “001” corresponds to decimal 1). In such an example, if combination {1, 2} corresponds to index value 1 in index C₄², then the combination can be encoded as binary “001” using 3 bits. As another example, index C₄ has 16 (or 15 if null is excluded) index values corresponding to all 16 possible combinations from the set of 4 possible beams (e.g., { }, {1}, {2}, {3}, {4}, {1, 2}, {1, 3}, {1, 4}, {2, 3}, {2, 4}, {3, 4}, {1, 2, 3}, {1, 2, 4}, {1, 3, 4}, {2, 3, 4}, {1, 2, 3, 4}), and these 16 combinations can be represented using 4 bits. In such an example, if combination {1, 2} corresponds to index value 6 in index C₄, then the combination can be encoded as binary “0110” using 4 bits. In some aspects, the number of bits can be reduced by dynamically adjusting the number of bits used to represent the number of selected beams n to be no greater than required to represent n, and using an index Cₘⁿ, corresponding to only those combinations that include n elements. Alternatively, if an index Cₘ of all combinations from the set of m selectable beams is used to identify which combination of beams is selected (with or without bits to represent the number of selected beams), the number of bits used to represent a combination of beams can remain constant regardless of how many beams are selected, which can reduce the amount of auxiliary information provided to a scheduled entity (e.g., scheduled entity 906) for the purpose of determining which bits identify the combination of beams. For example, the number of bits can be determined based only on m, rather than specifying a number of bits used to represent n and a number of bits used to represent an index value Cⁿₘ(i).

In some aspects, the list can be expressed as an ordered combination of a string of ┌log₂ m┐ bits (i.e., the minimum number of bits that can be used to represent a number not larger than m) or ┌log₂ n┐ bits (i.e., the minimum number of bits that can be used to represent a number not larger than a current value of n) used to represent the number of selected beams in the ordered list, and a string of ┌log₂|Cₘⁿ|┐ bits (i.e., the minimum number of bits that can be used to represent the value of a number not larger than the number of index values in the index Cₘⁿ) used to represent which particular combination of the n beams are associated with the multicast session. For example, beams selected to transmit multicast session 1 in Table 1 can be expressed using 5 bits as

$${\underbrace{01}}_{n = 2} {\underbrace{000}}_{{C}_{4}^{2} ( i )} ,$$

where the tirst two hits (┌log₂ 4┐=2) represents the total number of beams from which the combination was drawn (e.g., two beams, represented by binary “01” where “00” represents a decimal 1) and the last three bits (┌log₂|C₄²|┐=3) represent the index of combination when the total number of beams are set (e.g., “000” can represent the 1^{st} possible combination {1,2} among all the combinations including two beams).

As described above, in some aspects, an index Cₘ can be used in lieu of index Cₘⁿ to represent all possible combinations from the selectable beams m (e.g., with or without the null set). For example, if there are 4 possible multicast beams, there are 16 possible combinations of those 4 beams (e.g., { }, {1}, {2}, {3}, {4}, {1, 2}, {1, 3}, {1, 4}, {2, 3}, {2, 4}, {3, 4}, {1, 2, 3}, {1, 2, 4}, {1, 3, 4}, {2, 3, 4}, {1, 2, 3, 4}). Each combination can be identified using a unique index number Cₘ(i). In such an example, each combination can be associated with an integer index value in a range of 0-15 (or 1-16), which can be represented using 4 bits, and the total number of selected beams can be represented using no more than 3 bits (or 2 bits e.g., by using binary “00” to represent 1 selectable beam rather than 0, since a sorted list is not necessary if 0 beams are being used to transmit a particular multicast session, and thus binary “11” can be used to represent 4 selectable beams). Additionally, in some aspects, the number of selected beams can be omitted if index Cₘ is used as the index value can identify the combination of beams without first selecting an index based on the number of selected beams. Note that in some aspects, a binary 0 can represent a null set, however, null set can be omitted from the possible combinations as again this would indicate that 0 beams are being used to transmit a particular multicast session, which can be conveyed by simply omitting information about that multicast session altogether. In some aspects, an index of combinations (e.g., Cₘⁿ or Cₘ) can be stored as a lookup table, or other suitable data structure, and a scheduling entity and/or scheduled entity can determine which combination of beams are selected for a multicast session by using the combination index value (e.g., Cₘⁿ(i)) in the lookup table or vice versa (e.g., using the combination to lookup the index value). In some aspects, scheduled entity 908 can configure such a lookup table (or other suitable data structure). In some aspects, multiple lookup tables can be stored corresponding to various numbers of selected beams (e.g., a first lookup table for index Cₘ¹, a second lookup table for index Cₘ², etc.).

In some aspect, the number of bits used to represent the sorted list of multicast beams can be included in a system information block (SIB). For example, if the list is represented by beam indexes, a field in the SIB can represent the bits used to represent each index. As another example, if the list is represented by an index of combinations (e.g., Cₘⁿ or Cₘ), a field in the SIB can represent the bits used to convey n, and/or a second field in the SIB can represent the number of bits used to convey the index value in the index (e.g., index Cₘⁿ or index Cₘ). In such an example, the number of selected beams n can be used to determine which index to use to identify the particular combination of beams.

At 918, scheduling entity 908 can transmit information indicative of a sorted list of beams for each multicast session that scheduled entity 906 indicated it was interested in accessing. In some aspects, scheduling entity 908 can transmit information indicative of a sorted list of beams using any suitable technique or combination of techniques. For example, scheduling entity 908 can use any suitable signaling to communicate the information indicative of a sorted list of beams, such as via an RRC message, a MAC CE, or downlink control information (DCI). In a more particular example, scheduling entity 908 can use RRC signaling to communicate the information indicative of a sorted list of beams, such as a SIB (e.g., that includes sorted lists for all multicast sessions being transmitted by scheduling entity 908) and/or RRC messages directed to individual scheduled entities (e.g., that includes sorted lists for only multicast sessions that the scheduled entity is interested in accessing). Such an example may be well suited to scheduled entities that are stationary or that can be expected to move relatively slowly (e.g., UEs associated with infrastructure).

As another more particular example, scheduling entity 908 can use DCI to communicate the information indicative of a sorted list of beams, such as DCI intended for a group of scheduled entities (e.g., group common DCI that includes sorted lists applicable to all multicast sessions that a member of the group is interested in accessing), and/or DCI directed to individual scheduled entities (e.g., that includes sorted lists for only multicast sessions that the scheduled entity is interested in accessing). Such an example may be well suited to scheduled entities that can be expected to move relatively quickly (e.g., UEs associated with vehicles, UEs carried by a person, etc.). In some aspects, scheduling entity 908 can transmit a DCI that grants multicast data transfer, in which the transmission configuration indication (TCI) field indicates a sorted list of beams. For example, the TCI field can include a list of quasi-co-location (QCL) information values that are each associated with one of the sorted lists of multicast beams for a particular multicast session.

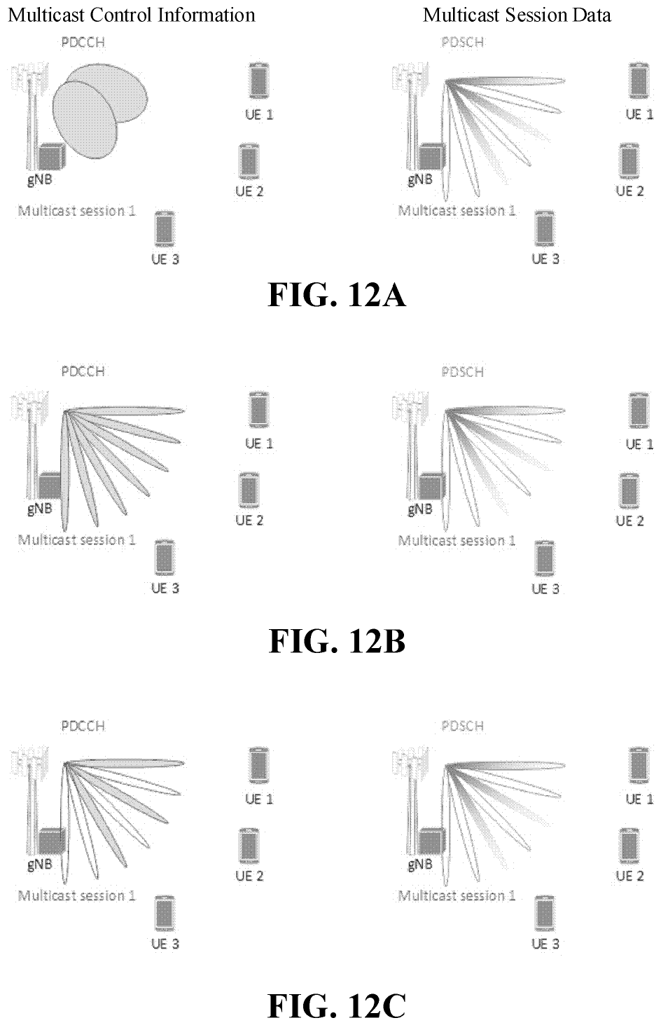

In some aspects, scheduling entity 908 can transmit information indicative of a sorted list of beams (e.g., an RRC message, a MAC CE, DCI, etc.) using any suitable communication interface, such as a transceiver (e.g., transceiver 710) and any suitable communication network (e.g., via a RAN, such as RAN 104 or RAN 200, using one or more DL slots, etc.). As described above, in some aspects, scheduling entity 908 can use beam sweeping techniques (e.g., if such information is being broadcast) and/or beamforming techniques (e.g., if such information is being transmitted for a particular scheduled entity) to transmit information indicative of a sorted list of beams. In some aspects, scheduling entity 908 can transmit information indicative of a sorted list of beams and/or any other suitable control information associated with the multicast session(s) on the physical downlink control channel (PDCCH). For example, scheduling entity 908 can transmit information indicative of a sorted list of beams and/or any other suitable control information associated with the multicast session(s) on PDCCH using a single radio resource on a common wide beam (e.g., as described below, and shown in, FIG. 12A) that covers all of the scheduling entities from which a report was received at 914. In such an example, the coverage of the beam can be determined by selecting a beam that covers the union of the coverages of all beams used to transmit the multicast session(s) (e.g., any beam that is included in a sorted list associated with any multicast session). As another example, scheduling entity 908 can transmit information indicative of a sorted list of beams and/or any other suitable control information associated with the multicast session(s) on PDCCH using radio resources associated with all of the candidate multicast beams transmitted at 910 (e.g., scheduling entity 908 can use beams associated with the SSBs and/or CSI-RSs transmitted at 910, as described below, and shown in, FIG. 12B). As yet another example, scheduling entity 908 can transmit information indicative of a sorted list of beams and/or any other suitable control information associated with the multicast session(s) on PDCCH using beams included in a sorted list associated with any multicast session (e.g., beams corresponding to the PDSCH beams used to transmit the multicast data for the multicast sessions, as described below, and shown in, FIG. 12C).

In some aspects, scheduled entity 906 can use any suitable technique or combination of techniques to receive the information transmitted by scheduling entity 906 at 918. For example, scheduled entity 906 can sample and buffer a received wireless signal encoded with the information, and apply suitable processing to the buffered signal such as energy detection, demodulation, decoding, etc. In some aspects, scheduled entity 906 can receive the information using any suitable communication interface, such as a transceiver (e.g., transceiver 810).

At 920, scheduling entity 908 can transmit multicast data for each multicast session using the beams in the sorted list of beams associated that multicast session. In some aspects, scheduling entity 908 can use any suitable technique or combination of techniques to transmit the multicast data. For example, scheduling entity 908 can transmit multicast data for each multicast session using the physical downlink shared channel (PDSCH). In a more particular example, scheduling entity 908 can transmit multicast data for each multicast session using the same number of radio resources as beams in the sorted list for that multicast session (e.g., if there are two beams in the sorted list, each beam can use one radio resource). In some aspects, radio resources used to transmit the multicast data can be time domain multiplexed (TDM) and/or frequency domain multiplexed (FDM). In some aspects, multicast data associated with a particular multicast session can be associated with a group radio network temporary identity (G-RNTI) that can be used to scramble the cyclic redundancy check (CRC) portion of the transport block and/or code blocks used to transmit the multicast data. Note that different multicast sessions can be associated with different G-RNTI values, even if the multicast sessions are being transmitted using the same set of beams.

In some aspects, scheduling entity 908 can transmit multicast data using any suitable communication interface, such as a transceiver (e.g., transceiver 710) and any suitable communication network (e.g., via a RAN, such as RAN 104 or RAN 200, using one or more DL slots, etc.).

At 922, scheduled entity 906 can selectively receive the multicast data associated with one or more multicast sessions using a beam indicated by the sorted list of beams associated with each multicast session. In some aspects, scheduled entity 906 can use any suitable technique or combination of techniques to receive the multicast data transmitted by scheduling entity 906 at 920. For example, scheduled entity 906 can sample and buffer a received wireless signal encoded with the multicast data, and apply suitable processing to the buffered signal such as energy detection, demodulation, decoding, etc. In a more particular example, scheduled entity 906 can be receive the multicast data on a radio resource associated with a particular beam.

In some aspects, scheduled entity 906 can use the G-RNTI associated with the multicast session to descramble the CRC portion of the transport block and/or code blocks that are encoded with the multicast data.

In some aspects, scheduled entity 906 can use any suitable technique or combination of techniques to receive the multicast data transmitted by scheduling entity 906 at 920. For example, scheduled entity 906 can sample and buffer a received wireless signal encoded with the multicast data, and apply suitable processing to the buffered signal such as energy detection, demodulation, decoding, etc. In some aspects, scheduled entity 906 can receive the multicast data using any suitable communication interface, such as a transceiver (e.g., transceiver 810).

FIG. 10 is a flow chart illustrating an exemplary process 1000 for a scheduling entity to schedule multicast sessions on one or more beams for transmission to reduced capability user equipments in accordance with some aspects of the disclosed subject matter. At 1002, a scheduling entity (e.g., a base station, such as base station 108, base station 608, etc.) can periodically transmit one or more reference signals for candidate beams. For example, in some aspects, the base station can periodically (e.g., at regular and/or irregular intervals) transmit synchronization signal blocks (SSBs) and/or channel state information reference signals (CSI-RSs) using various beams that can be used to transmit multicast data associated with one or more multicast sessions. For example, as described above in connection with 910 of FIG. 9, the base station can transmit SSBs and/or CSI-RSs using every beam available for transmission of multicast data. In such an example, the base station can a beam sweeping technique to periodically (e.g., at regular and/or irregular intervals) transmit SSBs and/or CSI-RSs using every beam available for transmission of multicast data in a particular portion of a cell (e.g., a particular sector as described above in connection with FIG. 6A).

In some aspects, the base station can use any suitable technique or combination of techniques to transmit SSBs and/or CSI-RSs. For example, the base station can transmit the SSBs and/or CSI-RSs using any suitable communication network (e.g., via a RAN, such as RAN 104 or RAN 200, using one or more DL slots, etc.). In some aspects, the base station can transmit the SSBs and/or CSI-RSs using any suitable communication interface, such as a transceiver (e.g., transceiver 710). As described above, in some aspects, the base station can use beam sweeping techniques to transmit SSBs and/or CSI-RSs using beams that can be used to transmit multicast data.

At 1004, a base station can receive reports from one or more UEs (e.g., RedCap UEs) indicative of the best beams for transmitting multicast data to those UEs, and multicast sessions that the UEs are interested in accessing. In some aspects, the base station can receive any suitable information indicative of one or more beams that each of the UEs can use to receive multicast data. Additionally, in some aspects, the base station can receive information indicative of which multicast session or sessions each UE is interested in accessing.

In some aspects, the information indicative of one or more beams that a UE can use to receive multicast data can be explicit information identifying one or more beams (e.g., by SSB beam index, CSI-RS beam index, etc.) that the UE has determined are suitable for receiving multicast data from the base station. Additionally or alternatively, in some aspects, the information indicative of one or more beams that a UE can use to receive multicast data can be implicit information indicative of one or more suitable beams, such as quality information associated with one or more beams (e.g., by SSB beam index, CSI-RS beam index, etc.). In some aspects, the reports received from the UEs at 1004 can be a CSI report (e.g., a CSI report for multicast).

In some aspects, the base station can use any suitable technique or combination of techniques to receive the information indicative of one or more beams that each UE can use to receive multicast data and/or information indicative of which multicast session or sessions each UE is interested in accessing. In some aspects, the base station can use any suitable technique or combination of techniques to receive the information transmitted by the UEs. For example, the base station can sample and buffer a received wireless signal encoded with the information, and apply suitable processing to the buffered signal such as energy detection, demodulation, decoding, etc. In some aspects, the base station can receive the information indicative of one or more beams that the UE can use to receive multicast data using any suitable communication interface, such as a transceiver (e.g., transceiver 710).

In some aspects, the base station can receive information transmitted by multiple UEs within a cell or portion of a cell covered by scheduling entity. For example, each UE that is interested in accessing at least one multicast session can transmit information indicative of one or more beams that the UE can use to receive multicast data and/or information indicative of which multicast session or sessions that the UE is interested in accessing. In some aspects, only certain types of UEs (e.g., only RedCap UEs; only RedCap UEs and eMBB UEs; only RedCap UEs, eMBB UEs, and URLLC UEs, etc.) can transmit such information. Alternatively, in some aspects, each UE that is interested in accessing at least one multicast session, regardless of the type of UE, can be required to transmit information indicative of one or more beams that the UE can use to receive multicast data and/or information indicative of which multicast session or sessions that the UE is interested in accessing.

At 1006, a base station can determine a sorted list of beams to use to transmit each multicast session based on the reports received at 1004. In some aspects, the base station can use information indicative of one or more beams that UEs can use to receive multicast data to determine which beam or beams to use to transmit multicast sessions. For example, as described above in connection with 916 of FIG. 9, the base station can determine, for each multicast session, a minimum number of beams that can be used to cover all of the UEs that are interested in accessing that multicast session.

As described above in connection with 916 of FIG. 9, in some aspects, the base station can determine whether a particular beam can cover a UE for a particular multicast session. For example, the base station can derive a physical layer SINR threshold, and can compare a physical layer SINR value reported by each scheduled entity for each beam to the threshold.

In some aspects, the base station can format the sorted lists associated with each multicast session using any suitable technique or combination of techniques, such as techniques described above in connection with 916 of FIG. 9.

At 1008, a base station can transmit information indicative of the sorted list(s) to the UEs that are interested in accessing a multicast session transmitted by the base station. In some aspects, the base station can transmit information indicative of a sorted list of beams using any suitable technique or combination of techniques, such as techniques described above in connection with 918 of FIG. 9.

In some aspects, the base station can transmit information indicative of a sorted list of beams (e.g., an RRC message, a MAC CE, DCI, etc.) using any suitable communication interface, such as a transceiver (e.g., transceiver 710) and any suitable communication network (e.g., via a RAN, such as RAN 104 or RAN 200, using one or more DL slots, etc.). As described above in connection with 918 of FIG. 9, in some aspects, the base station can use beam sweeping techniques (e.g., if such information is being broadcast) and/or beamforming techniques (e.g., if such information is being transmitted for a particular scheduled entity) to transmit information indicative of a sorted list of beams. In some aspects, the base station can transmit information indicative of a sorted list of beams and/or any other suitable control information associated with the multicast session(s) on the physical downlink control channel (PDCCH), for example, using one or more techniques described above in connection with 918 of FIG. 9.

At 1010, a base station can transmit multicast data for each multicast session using beams include in the sorted list for that multicast session. In some aspects, the base station can use any suitable technique or combination of techniques to transmit the multicast data, such as one or more techniques described above in connection with 920 of FIG. 9. In some aspects, the base station can transmit multicast data using any suitable communication interface, such as a transceiver (e.g., transceiver 710) and any suitable communication network (e.g., via a RAN, such as RAN 104 or RAN 200, using one or more DL slots, etc.).

FIG. 11 is a flow chart illustrating an exemplary process 1100 for a scheduled entity to receive one or more multicast sessions on a preferred beam(s) in accordance with some aspects of the disclosed subject matter. At 1102, a scheduled entity (e.g., a UE such as a RedCap UE), can receive one or more reference signals (e.g., one or more SSBs and/or CSI-RSs) on candidate beams. For example, in some aspects, the UE can periodically (e.g., at regular and/or irregular intervals) attempt to receive synchronization signal blocks (SSBs) and/or channel state information reference signals (CSI-RSs) transmitted using various beams that can be used to transmit multicast data associated with one or more multicast sessions. For example, as described above in connection with 910 of FIG. 9, the UE can attempt to receive SSBs and/or CSI-RSs transmitted using every beam available for transmission of multicast data. In such an example, the UE can attempt to receive SSBs and/or CSI-RSs using every beam available for transmission of multicast data in a particular portion of a cell (e.g., a particular sector as described above in connection with FIG. 6A).

In some aspects, the UE can use any suitable technique or combination of techniques to receive the one or more SSBs and/or CSI-RSs. For example, the UE can sample and buffer a received wireless signal comprising an SSB or a CSI-RS, and apply suitable processing to the buffered signal such as energy detection, demodulation, decoding, etc. In some aspects, the UE can receive the one or more SSBs and/or CSI-RSs using any suitable communication interface, such as a transceiver (e.g., transceiver 810).

At 1104, a UE can determine one or more measurements of channel quality for one or more candidate beams. In some aspects, the UE can measure any suitable channel quality parameters based on the one or more SSBs and/or CSI-RSs using any suitable technique or combination of techniques, such as techniques described above in connection with 912 of FIG. 9.

At 1106, a UE can generate a report(s) indicative of the best beams for transmitting multicast data to the UE, and multicast sessions that the UE are interested in accessing. In some aspects, the UE can use any suitable technique or combination of techniques to generate the report, such as techniques described above in connection with 912 of FIG. 9.

At 1108, a UE can transmit the report(s) to the scheduling entity (e.g., a base station) that transmitted the reference signal(s) received at 1102. In some aspects, the UE can use any suitable technique or combination of techniques to transmit the report(s), such as techniques described above in connection with 914 of FIG. 9. For example, the UE can transmit the report(s) using any suitable communication network (e.g., via a RAN, such as RAN 104 or RAN 200, using one or more DL slots, etc.). As another example, the UE can transmit the report(s) using any suitable signaling, such as via an RRC message, a MAC CE, UCI, and/or any other suitable signaling. In some aspects, the UE can transmit the report(s) using any suitable communication interface, such as a transceiver (e.g., transceiver 810).

At 1110, a UE can receive information indicative of a sorted list of beams that a scheduling entity (e.g., a base station) has scheduled for transmission of multicast data associated with the one or more multicast sessions. In some aspect, the UE can use any suitable technique or combination of techniques to receive such information, such as one or more techniques described above in connection with 918 of FIG. 9. For example, the UE can sample and buffer a received wireless signal encoded with the information, and apply suitable processing to the buffered signal such as energy detection, demodulation, decoding, etc. In some aspects, the UE can receive the information using any suitable communication interface, such as a transceiver (e.g., transceiver 810).

In some aspects, the information indicative of the sorted lists associated with each multicast session can be formatted using any suitable technique or combination of techniques, such as techniques described above in connection with 916 of FIG. 9.

In some aspects, the UE can receive the information indicative of a sorted list of beams in any suitable format (e.g., an RRC message, a MAC CE, DCI, etc.) using any suitable communication network (e.g., via a RAN, such as RAN 104 or RAN 200, using one or more DL slots, etc.). In some aspects, the UE can receive the information indicative of a sorted list of beams and/or any other suitable control information associated with the multicast session(s) on the physical downlink control channel (PDCCH), for example, using one or more techniques described above in connection with 918 of FIG. 9.

At 1112, a UE can receive multicast data associated with one or more multicast sessions using beams based on the information indicative of the sorted list(s). In some aspects, the UE can use any suitable technique or combination of techniques to receive the multicast data, such as one or more techniques described above in connection with 920 and/or 922 of FIG. 9. In some aspects, the UE can use any suitable technique or combination of techniques to receive the multicast data transmitted by the base station. For example, the UE can sample and buffer a received wireless signal encoded with the multicast data, and apply suitable processing to the buffered signal such as energy detection, demodulation, decoding, etc. In some aspects, the UE can receive the multicast data using any suitable communication interface, such as a transceiver (e.g., transceiver 810) and any suitable communication network (e.g., via a RAN, such as RAN 104 or RAN 200, using one or more DL slots, etc.).

FIGS. 12A to 12C are schematic illustrations of techniques for transmitting control information related to multicast data, and beams that can be used to transmit multicast data in accordance with some aspects of the disclosed subject matter. As shown in FIG. 12A, a base station (e.g., gNB) can use wide beams to transmit control information associated with a multicast session to multiple UEs (e.g., RedCap UEs), and narrow beams (e.g., selected using one or more techniques described above in connection with FIGS. 9-11) to transmit the multicast data associated with the multicast session to the UEs.

As shown in FIG. 12B, a base station (e.g., gNB) can use multiple narrow beams to transmit control information associated with a multicast session to multiple UEs (e.g., RedCap UEs) by beam sweeping, and can use a subset of narrow beams (e.g., selected using one or more techniques described above in connection with FIGS. 9-11) to transmit the multicast data associated with the multicast session to the UEs.

As shown in FIG. 12C, a base station (e.g., gNB) can use the same set of narrow beams (e.g., selected using one or more techniques described above in connection with FIGS. 9-11) to transmit control information associated with a multicast session, and multicast data associated with the multicast session to the multiple UEs (e.g., RedCap UEs). In some aspects, a base station can consistently use the same technique to transmit control information. Alternatively, in some aspects, a base station can consistently use multiple techniques to transmit control information. For example, the base station can switch techniques periodically (e.g., at regular or irregular intervals).

FIG. 13 is a schematic illustration of beams that can be used to transmit reference signals, and beams that can be used to transmit multicast data associated with different multicast sessions to regular capability device and reduced capability devices in accordance with some aspects of the disclosed subject matter. As shown in FIG. 13, a base station (e.g., gNB) can use all available beams to transmit one or more reference signals (e.g., SSBs as shown in FIG. 13, CSI-RSs, etc.) by beam sweeping. As shown in FIG. 13, regular capability UEs (e.g., eMBB, and/or URLLC UEs) can use relatively wide beams to access multicast data. For example, as described above in connection with FIG. 1, a regular capability UE may have more Rx antennas and/or better processing gain, and thus may be capable of accessing multicast data that is transmitted with less beamforming gain (e.g., transmitted using a relatively wide beam, as shown in FIG. 13). However, a RedCap UE may not be capable of reliably decoding multicast data that is transmitted with relatively low beamforming gain (e.g., using the same wide beams that can be used by eMBB UEs), depending on the latency and/or peak data rate of the multicast session. As shown in FIG. 13, the base station can select a set of narrow beams to transmit multicast session data that can be selected using one or more techniques described above in connection with FIGS. 9-11. For example, for multicast session 1, the base station selected three beams to cover UE 1, UE 2, and UE 3, and for multicast session 2, the base station selected a different set of three beams to cover UE 4, UE 5, and UE 6. This can facilitate transmission of multicast data with high beamforming gain while conserving radio resources by inhibiting transmission on beams that may not cover any UEs that are interested in the multicast session and/or that beams that are unnecessary (e.g., because a UE is covered by two beams).

### Examples Having a Variety of Features

Example 1: A method, apparatus, system, and non-transitory computer-readable medium for wireless communication, including: transmitting, from a user equipment (UE) to a base station, information indicative of a multicast session that the UE is interested in accessing; transmitting information indicating that a first beam of a plurality of beams is a preferred beam for receiving multicast data associated with the multicast session; receiving, from the base station, a list of at least one beam of the plurality of beams associated with the multicast session; and receiving, from the base station using a beam from the list, multicast data associated with the multicast session.

Example 2: A method, apparatus, system, and non-transitory computer-readable medium of Example 1, further including: transmitting, to the base station, information indicative of channel quality associated with the first beam of a plurality of beams transmitted by the base station.

Example 3: A method, apparatus, system, and non-transitory computer-readable medium of any of Examples 1 to 2, further including: receiving, from the base station, one or more reference signals transmitted using the first beam; estimating a parameter indicative of channel quality of the first beam using the one or more reference signals; and wherein transmitting the information indicative of channel quality associated with the first beam comprises transmitting the parameter indicative of channel quality of the first beam.

Example 4: A method, apparatus, system, and non-transitory computer-readable medium of any of Examples 1 to 3, wherein the one or more reference signals transmitted using the first beam comprises a synchronization signal block (SSB).

Example 5: A method, apparatus, system, and non-transitory computer-readable medium of any of Examples 1 to 4, wherein the one or more reference signals transmitted using the first beam comprises a channel state information reference signal (CSI-RS).

Example 6: A method, apparatus, system, and non-transitory computer-readable medium of any of Examples 1 to 5, wherein the parameter indicative of channel quality is a signal-to-interference-and-noise ratio (SINR) parameter.

Example 7: A method, apparatus, system, and non-transitory computer-readable medium of any of Examples 1 to 6, wherein the information indicative of channel quality associated with a first beam comprises a channel state information (CSI) report.

Example 8: A method, apparatus, system, and non-transitory computer-readable medium of any of Examples 1 to 7, wherein the information indicative of channel quality associated with a first beam comprises quasi co-location (QCL) information associated with the first beam.

Example 9: A method, apparatus, system, and non-transitory computer-readable medium of any of Examples 1 to 8, wherein the information indicative of the preferred beam comprises a beam index associated with the first beam.

Example 10: A method, apparatus, system, and non-transitory computer-readable medium of any of Examples 1 to 9, further including: selecting the first beam as the preferred beam for receiving multicast data associated with the multicast session based on the information indicative of channel quality of the first beam.

Example 11: A method, apparatus, system, and non-transitory computer-readable medium of any of Examples 1 to 10, wherein receiving the list of at least one beam of the plurality of beams associated with the multicast session comprises receiving one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

Example 12: A method, apparatus, system, and non-transitory computer-readable medium of any of Examples 1 to 11, wherein the list of at least one beam of the plurality of beams associated with the multicast session comprises at least one quasi-co-location (QCL) information value that is associated with the at least one beam, and wherein the DCI comprises a transmission configuration indication (TCI) field that includes the at least one QCL information value.

Example 13: A method, apparatus, system, and non-transitory computer-readable medium of any of Examples 1 to 12, wherein the list of at least one beam of the plurality of beams associated with the multicast session comprises a plurality of beam indexes corresponding to the at least one beam and at least one second beam associated with the multicast session.

Example 14: A method, apparatus, system, and non-transitory computer-readable medium of any of Examples 1 to 13, further including: receiving, from the base station, a system information block (SIB) comprising a field that indicates the number of bits used to represent each of the plurality of beam indexes.

Example 15: A method, apparatus, system, and non-transitory computer-readable medium of any of Examples 1 to 14, wherein the list of at least one beam of the plurality of beams associated with the multicast session comprises: a combination index value i that corresponds to a particular combination of n beams in a combination index Cₘⁿ, where n is the number of selected beams associated with the multicast session and m is the number of selectable beams; or a combination index value i that corresponds to a particular combination of n beams in a combination index Cₘ that includes index values corresponding to combinations of any number of beams of the m selectable beams.

Example 16: A method, apparatus, system, and non-transitory computer-readable medium of any of Examples 1 to 15, wherein the list of at least one beam of the plurality of beams associated with the multicast session comprises a value n.

Example 17: A method, apparatus, system, and non-transitory computer-readable medium of any of Examples 1 to 16, further including: receiving, from the base station, a system information block (SIB) comprising a first field that indicates the number of bits used to convey n, and a second field that indicates the number of bits used to convey the combination index value i.

Example 18: A method, apparatus, system, and non-transitory computer-readable medium of any of Examples 1 to 17, wherein receiving the list of at least one beam of the plurality of beams associated with the multicast session comprises receiving the list of at least one beam of the plurality of beams associated with the multicast session on a physical data control channel (PDCCH) via one or more of the following: a wide beam that covers at least two of the plurality of beams; a beam of the plurality of beams; or the beam from the list that is used to receive the multicast data associated with the multicast session.

Example 19: A method, apparatus, system, and non-transitory computer-readable medium of any of Examples 1 to 18, wherein receiving the multicast data associated with the multicast session comprises receiving a plurality of code blocks comprising the multicast data on a physical downlink shared channel (PDSCH) using the beam from the list, and wherein the method further comprises: receiving a group radio network temporary identifier (G-RNTI); and descrambling a cyclic redundancy check (CRC) portion of each of the plurality of code blocks using the G-RNTI.

Example 20: A method, apparatus, system, and non-transitory computer-readable medium of any of Examples 1 to 19, further including: receiving, from the base station, a second list of at least one beam of the plurality of beams associated with a second multicast session; receiving a second G-RNTI associated with the second multicast session; receiving, from the base station using a beam from the second list, a second plurality of code blocks comprising multicast data associated with the second multicast session; and descrambling a cyclic redundancy check (CRC) portion of each of the second plurality of code blocks using the second G-RNTI.

Example 21: A method, apparatus, system, and non-transitory computer-readable medium of any of Examples 1 to 20, wherein receiving the plurality of code blocks comprises: receiving the plurality of code blocks in a first radio resource associated with the beam from the list; and receiving the second plurality of code blocks in a second radio resource associated with the beam from the second list, wherein the first radio resource and the second radio resource are different.

Example 22: A method, apparatus, system, and non-transitory computer-readable medium of any one of Examples 1 to 21, further including: transmitting, to one or more user equipments (UEs), a list of at least one beam of a plurality of beams associated with a multicast session that the one or more UEs are interested in accessing; and transmitting multicast data associated with the multicast session using the at least one beam from the list.

Example 23: method, apparatus, system, and non-transitory computer-readable medium for wireless communication, including: transmitting, to one or more user equipments (UEs), a list of at least one beam of a plurality of beams associated with a multicast session that the one or more UEs are interested in accessing; and transmitting multicast data associated with the multicast session using the at least one beam from the list.

Example 24: A method, apparatus, system, and non-transitory computer-readable medium of any one of Examples 1 to 23, further including: receiving, from a first UE of the one or more UEs, information indicating that the first UE is interested in accessing the multicast session.

Example 25: A method, apparatus, system, and non-transitory computer-readable medium of any one of Examples 1 to 24 further including: receiving, from a first UE, information indicating that a first beam of the plurality of beams is a preferred beam for receiving multicast data associated with the multicast session.

Example 26: A method, apparatus, system, and non-transitory computer-readable medium of any one of Examples 1 to 25, further including: receiving, from a second UE, information indicating that the first beam and a second beam of the plurality of beams are preferred beams for receiving multicast data associated with the multicast session.

Example 28: A method, apparatus, system, and non-transitory computer-readable medium of any one of Examples 1 to 26, further including: determining the list of at least one beam based on the information indicating that the first beam is preferred by the first UE and the information indicating that the first beam is preferred by the second UE.

Example 29: A method, apparatus, system, and non-transitory computer-readable medium of any one of Examples 1 to 27, wherein determining the list further comprises: selecting the first beam for inclusion in the list of at least one beam; and excluding the second beam from inclusion in the list of at least one beam.

Example 30: A method, apparatus, system, and non-transitory computer-readable medium of any one of Examples 1 to 28, wherein determining the list further comprises: receiving, from the first UE, first information indicative of channel quality associated with the first beam; receiving, from the second UE, second information indicative of channel quality associated with the first beam; determining that the first UE and the second UE are covered by the first beam based on the first information indicative of channel quality and the second information indicative of channel quality; and selecting the first beam for inclusion in the list of at least one beam in response to determining that that the first UE and the second UE are covered by the first beam.

Example 31: A method, apparatus, system, and non-transitory computer-readable medium of any one of Examples 1 to 29, further including: transmitting one or more reference signals using the first beam; receiving, from the first UE, information indicative of channel quality associated with the first beam.

Example 32: A method, apparatus, system, and non-transitory computer-readable medium of any one of Examples 1 to 30, wherein the one or more reference signals transmitted using the first beam comprises a synchronization signal block (SSB).

Example 33: A method, apparatus, system, and non-transitory computer-readable medium of any one of Examples 1 to 31, wherein the one or more reference signals transmitted using the first beam comprises a channel state information reference signal (CSI-RS).

Example 34: A method, apparatus, system, and non-transitory computer-readable medium of any one of Examples 1 to 32, wherein the parameter indicative of channel quality is a signal-to-interference-and-noise ratio (SINR) parameter.

Example 35: A method, apparatus, system, and non-transitory computer-readable medium of any one of Examples 1 to 33

Example 36: A method, apparatus, system, and non-transitory computer-readable medium of any one of Examples 1 to 34, wherein the information indicative of channel quality associated with a first beam comprises a channel state information (CSI) report.

Example 37: A method, apparatus, system, and non-transitory computer-readable medium of any one of Examples 1 to 35 wherein the information indicative of channel quality associated with a first beam comprises quasi co-location (QCL) information associated with the first beam.

Example 38: A method, apparatus, system, and non-transitory computer-readable medium of any one of Examples 1 to 36 wherein the information indicative of the preferred beam comprises a beam index associated with the first beam.

Example 39: A method, apparatus, system, and non-transitory computer-readable medium of any one of Examples 1 to 37, wherein transmitting the list of at least one beam of the plurality of beams associated with the multicast session comprises transmitting one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

Example 40: A method, apparatus, system, and non-transitory computer-readable medium of any one of Examples 1 to 38, wherein the list of at least one beam of the plurality of beams associated with the multicast session comprises at least one quasi-co-location (QCL) information value that is associated with the at least one beam, and wherein the DCI comprises a transmission configuration indication (TCI) field that includes the at least one QCL information value.

Example 41: A method, apparatus, system, and non-transitory computer-readable medium of any one of Examples 1 to 39, wherein the list of at least one beam of the plurality of beams associated with the multicast session comprises a plurality of beam indexes corresponding to the at least one beam and at least one second beam associated with the multicast session.

Example 42: A method, apparatus, system, and non-transitory computer-readable medium of any one of Examples 1 to 41, further including: transmitting a system information block (SIB) comprising a field that indicates the number of bits used to represent each of the plurality of beam indexes.

Example 43: A method, apparatus, system, and non-transitory computer-readable medium of any one of Examples 1 to 42, wherein the list of at least one beam of the plurality of beams associated with the multicast session comprises: a combination index value i that corresponds to a particular combination of beams in a combination index Cₘⁿ, where n is the number of selected beams associated with the multicast session and m is the number of selectable beams; or a combination index value i that corresponds to a particular combination of n beams in a combination index Cₘ that includes index values corresponding to combinations of any number of beams of the m selectable beams.

Example 44: A method, apparatus, system, and non-transitory computer-readable medium of any one of Examples 1 to 43, wherein the list of at least one beam of the plurality of beams associated with the multicast session comprises a value n.

Example 45: A method, apparatus, system, and non-transitory computer-readable medium of any one of Examples 1 to 44, further comprising: transmitting a system information block (SIB) comprising a first field that indicates the number of bits used to convey n, and a second field that indicates the number of bits used to convey the combination index value i.

Example 46: A method, apparatus, system, and non-transitory computer-readable medium of any one of Examples 1 to 45, wherein transmitting the list of at least one beam of the plurality of beams associated with the multicast session comprises transmitting the list of at least one beam of the plurality of beams associated with the multicast session on a physical data control channel (PDCCH) via one or more of the following: a wide beam that covers at least two of the plurality of beams; a beam of the plurality of beams; or the beam from the list that is used to receive the multicast data associated with the multicast session.

Example 47: A method, apparatus, system, and non-transitory computer-readable medium of any one of Examples 1 to 46, wherein transmitting the multicast data associated with the multicast session comprises transmitting a plurality of code blocks comprising the multicast data on a physical downlink shared channel (PDSCH) using the at least one beam, and wherein the method further comprises: transmitting, to the one or more UEs, a group radio network temporary identifier (G-RNTI); and scrambling a cyclic redundancy check (CRC) portion of each of the plurality of code blocks using the G-RNTI.

Example 48: A method, apparatus, system, and non-transitory computer-readable medium of any one of Examples 1 to 47, further including: transmitting, to the one or more UEs, a second list of at least one beam of the plurality of beams associated with a second multicast session; transmitting, to the one or more UEs, a second G-RNTI associated with the second multicast session; transmitting, using a beam from the second list, a second plurality of code blocks comprising multicast data associated with the second multicast session; and scrambling a cyclic redundancy check (CRC) portion of each of the second plurality of code blocks using the second G-RNTI.

Example 49: A method, apparatus, system, and non-transitory computer-readable medium of any one of Examples 1 to 48, wherein transmitting the plurality of code blocks comprises: transmitting the plurality of code blocks using a first radio resource associated with a first beam from the list; and transmitting the second plurality of code blocks using a second radio resource associated with a second beam from the second list, wherein the first radio resource and the second radio resource are different.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 can be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 can be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication, comprising:
transmitting, from a user equipment (UE) to a base station, information indicative of a multicast session that the UE is interested in accessing;
transmitting information indicating that a first beam of a plurality of beams is a preferred beam for receiving multicast data associated with the multicast session;
receiving, from the base station, a list of at least one beam of the plurality of beams associated with the multicast session; and
receiving, from the base station using a beam from the list, multicast data associated with the multicast session.

2. The method of claim 1, further comprising:
transmitting, to the base station, information indicative of channel quality associated with the first beam of a plurality of beams transmitted by the base station.

3. The method of claim 2, further comprising:
receiving, from the base station, one or more reference signals transmitted using the first beam;
estimating a parameter indicative of channel quality of the first beam using the one or more reference signals; and
wherein transmitting the information indicative of channel quality associated with the first beam comprises transmitting the parameter indicative of channel quality of the first beam.

4. The method of claim 3, wherein the one or more reference signals transmitted using the first beam comprises a synchronization signal block (SSB).

5. The method of claim 3, wherein the one or more reference signals transmitted using the first beam comprises a channel state information reference signal (CSI-RS).

6. The method of claim 3, wherein the parameter indicative of channel quality is a signal-to-interference-and-noise ratio (SINR) parameter.

7. The method of claim 2, wherein the information indicative of channel quality associated with a first beam comprises a channel state information (CSI) report.

8. The method of claim 2, wherein the information indicative of channel quality associated with a first beam comprises quasi co-location (QCL) information associated with the first beam.

9. The method of claim 2, wherein the information indicative of the preferred beam comprises a beam index associated with the first beam.

10. The method of claim 2, further comprising:
selecting the first beam as the preferred beam for receiving multicast data associated with the multicast session based on the information indicative of channel quality of the first beam.

11. The method of claim 1, wherein receiving the list of at least one beam of the plurality of beams associated with the multicast session comprises receiving one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

12. The method of claim 11, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

13. The method of claim 1, wherein the list of at least one beam of the plurality of beams associated with the multicast session comprises a plurality of beam indexes corresponding to the at least one beam and at least one second beam associated with the multicast session.

14. The method of claim 13, further comprising:
receiving, from the base station, a system information block (SIB) comprising a field that indicates the number of bits used to represent each of the plurality of beam indexes.

15. The method of claim 1, wherein the list of at least one beam of the plurality of beams associated with the multicast session comprises:
a combination index value i that corresponds to a particular combination of n beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

16. The method of claim 15, wherein the list of at least one beam of the plurality of beams associated with the multicast session comprises a value n.

17. The method of claim 16, further comprising:
receiving, from the base station, a system information block (SIB) comprising a first field that indicates the number of bits used to convey n, and a second field that indicates the number of bits used to convey the combination index value i.

18. The method of claim 1, wherein receiving the list of at least one beam of the plurality of beams associated with the multicast session comprises receiving the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

19. The method of claim 1, wherein receiving the multicast data associated with the multicast session comprises receiving a plurality of code blocks comprising the multicast data on a physical downlink shared channel (PDSCH) using the beam from the list, and
wherein the method further comprises:
receiving a group radio network temporary identifier (G-RNTI); and
descrambling a cyclic redundancy check (CRC) portion of each of the plurality of code blocks using the G-RNTI.

20. The method of claim 19, further comprising:
receiving, from the base station, a second list of at least one beam of the plurality of beams associated with a second multicast session;
receiving a second G-RNTI associated with the second multicast session;
receiving, from the base station using a beam from the second list, a second plurality of code blocks comprising multicast data associated with the second multicast session; and
descrambling a cyclic redundancy check (CRC) portion of each of the second plurality of code blocks using the second G-RNTI.

21. The method of claim 20, wherein receiving the plurality of code blocks comprises:
receiving the plurality of code blocks in a first radio resource associated with the beam from the list; and
receiving the second plurality of code blocks in a second radio resource associated with the beam from the second list, wherein the first radio resource and the second radio resource are different.

22. A wireless communication device, comprising:
a transceiver;
memory; and
a processor communicatively coupled to the transceiver and the memory, the processor configured to:
transmit, to a base station via the transceiver, information indicative of a multicast session that the wireless communication device is interested in accessing;
transmit, via the transceiver, information indicating that a first beam of a plurality of beams is a preferred beam for receiving multicast data associated with the multicast session;
receive, from the base station via the transceiver, a list of at least one beam of the plurality of beams associated with the multicast session; and
receive, using a beam from the list, multicast data associated with the multicast session.

23. The wireless communication device of claim 22, wherein the processor is further configured to:
transmit, to the base station via the transceiver, information indicative of channel quality associated with the first beam of a plurality of beams transmitted by the base station.

24. The wireless communication device of claim 23, wherein the processor is further configured to:
receive, from the base station via the transceiver, one or more reference signals transmitted using the first beam;
estimate a parameter indicative of channel quality of the first beam using the one or more reference signals; and
wherein the information indicative of channel quality comprises the parameter indicative of channel quality of the first beam.

25. The wireless communication device of claim 24, wherein the one or more reference signals transmitted using the first beam comprises a synchronization signal block (SSB).

26. The wireless communication device of claim 24, wherein the one or more reference signals transmitted using the first beam comprises a channel state information reference signal (CSI-RS).

27. The wireless communication device of claim 24, wherein the parameter indicative of channel quality is a signal-to-interference-and-noise ratio (SINR) parameter.

28. The wireless communication device of claim 23, wherein the information indicative of channel quality associated with a first beam comprises a channel state information (CSI) report.

29. The wireless communication device of claim 23, wherein the information indicative of channel quality associated with a first beam comprises quasi co-location (QCL) information associated with the first beam.

30. The wireless communication device of claim 23, wherein the information indicative of the preferred beam comprises a beam index associated with the first beam.

31. The wireless communication device of claim 23, wherein the processor is further configured to:
select the first beam as the preferred beam for receiving multicast data associated with the multicast session based on the information indicative of channel quality of the first beam.

32. The wireless communication device of claim 22, wherein the processor is further configured to:
receive the list of at least one beam of the plurality of beams associated with the multicast session via one or more of the following: a radio resource control (RRC) message; a media access control (MAC) control element (CE); or downlink control information (DCI), wherein the DCI is group-common DCI, DCI directed to the wireless communication device, or group-common DCI and DCI directed to the wireless communication device.

33. The wireless communication device of claim 32, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

34. The wireless communication device of claim 23, wherein the list of at least one beam of the plurality of beams associated with the multicast session comprises a plurality of beam indexes corresponding to the at least one beam and at least one second beam associated with the multicast session.

35. The wireless communication device of claim 34, wherein the processor is further configured to:
receive, from the base station via the transceiver, a system information block (SIB) comprising a field that indicates the number of bits used to represent each of the plurality of beam indexes.

36. The wireless communication device of claim 23, wherein the list of at least one beam of the plurality of beams associated with the multicast session comprises:
a combination index value i that corresponds to a particular combination of n beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

37. The wireless communication device of claim 36, wherein the list of at least one beam of the plurality of beams associated with the multicast session comprises a value n.

38. The wireless communication device of claim 37, wherein the processor is further configured to:
receive, from the base station via the transceiver, a system information block (SIB) comprising a first field that indicates the number of bits used to convey n, and a second field that indicates the number of bits used to convey the combination index value i.

39. The wireless communication device of claim 22, wherein the processor is further configured to receive the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

40. The wireless communication device of claim 22, wherein the processor is further configured to:
receive, on a physical downlink shared channel (PDSCH) using the beam from the list, the multicast data associated with the multicast session as a plurality of code blocks comprising the multicast data;
receive, via the transceiver, a group radio network temporary identifier (G-RNTI); and
descramble a cyclic redundancy check (CRC) portion of each of the plurality of code blocks using the G-RNTI.

41. The wireless communication device of claim 40, wherein the processor is further configured to:
receive, from the base station via the transceiver, a second list of at least one beam of the plurality of beams associated with a second multicast session;
receive, via the transceiver, a second G-RNTI associated with the second multicast session;
receive, using a beam from the second list, a second plurality of code blocks comprising multicast data associated with the second multicast session; and
descramble a cyclic redundancy check (CRC) portion of each of the second plurality of code blocks using the second G-RNTI.

42. The wireless communication device of claim 41, wherein the processor is further configured to:
receive the plurality of code blocks in a first radio resource associated with the beam from the list; and
receive the second plurality of code blocks in a second radio resource associated with the beam from the second list, wherein the first radio resource and the second radio resource are different.

43. A wireless communication device, comprising:
means for transmitting, to a base station, information indicative of a multicast session that the wireless communication device is interested in accessing;
means for transmitting information indicating that a first beam of a plurality of beams is a preferred beam for receiving multicast data associated with the multicast session;
means for receiving, from the base station, a list of at least one beam of the plurality of beams associated with the multicast session; and
means for receiving, from the base station using a beam from the list, multicast data associated with the multicast session.

44. The wireless communication device of claim 43, further comprising:
means for transmitting, to the base station, information indicative of channel quality associated with the first beam of a plurality of beams transmitted by the base station.

45. The wireless communication device of claim 44, further comprising:
means for receiving, from the base station, one or more reference signals transmitted using the first beam;
means for estimating a parameter indicative of channel quality of the first beam using the one or more reference signals; and
wherein the information indicative of channel quality comprises the parameter indicative of channel quality of the first beam.

46. The wireless communication device of claim 45, wherein the one or more reference signals transmitted using the first beam comprises a synchronization signal block (SSB).

47. The wireless communication device of claim 45, wherein the one or more reference signals transmitted using the first beam comprises a channel state information reference signal (CSI-RS).

48. The wireless communication device of claim 45, wherein the parameter indicative of channel quality is a signal-to-interference-and-noise ratio (SINR) parameter.

49. The wireless communication device of claim 44, wherein the information indicative of channel quality associated with a first beam comprises a channel state information (CSI) report.

50. The wireless communication device of claim 44, wherein the information indicative of channel quality associated with a first beam comprises quasi co-location (QCL) information associated with the first beam.

51. The wireless communication device of claim 44, wherein the information indicative of the preferred beam comprises a beam index associated with the first beam.

52. The wireless communication device of claim 44, further comprising:
means for selecting the first beam as the preferred beam for receiving multicast data associated with the multicast session based on the information indicative of channel quality of the first beam.

53. The wireless communication device of claim 43, wherein receiving the list of at least one beam of the plurality of beams associated with the multicast session comprises receiving one or more of the following: a radio resource control (RRC) message; a media access control (MAC) control element (CE); or downlink control information (DCI), wherein the DCI is group-common DCI, DCI directed to the wireless communication device, or group-common DCI and DCI directed to the wireless communication device.

54. The wireless communication device of claim 53, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

55. The wireless communication device of claim 43, wherein the list of at least one beam of the plurality of beams associated with the multicast session comprises a plurality of beam indexes corresponding to the at least one beam and at least one second beam associated with the multicast session.

56. The wireless communication device of claim 55, further comprising:
means for receiving, from the base station, a system information block (SIB) comprising a field that indicates the number of bits used to represent each of the plurality of beam indexes.

57. The wireless communication device of claim 43, wherein the list of at least one beam of the plurality of beams associated with the multicast session comprises:
a combination index value i that corresponds to a particular combination of n beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number beams of the m selectable beams.

58. The wireless communication device of claim 57, wherein the list of at least one beam of the plurality of beams associated with the multicast session comprises a value n.

59. The wireless communication device of claim 58, further comprising:
means for receiving, from the base station, a system information block (SIB) comprising a first field that indicates the number of bits used to convey n, and a second field that indicates the number of bits used to convey the combination index value i.

60. The wireless communication device of claim 43, wherein the means for receiving the list of at least one beam of the plurality of beams associated with the multicast session receives the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

61. The wireless communication device of claim 43, wherein the means for receiving the multicast data associated with the multicast session receives a plurality of code blocks comprising the multicast data on a physical downlink shared channel (PDSCH) using the beam from the list, and
wherein the wireless communication device further comprises:
means for receiving a group radio network temporary identifier (G-RNTI); and
means for descrambling a cyclic redundancy check (CRC) portion of each of the plurality of code blocks using the G-RNTI.

62. The wireless communication device of claim 61, further comprising:
means for receiving, from the base station, a second list of at least one beam of the plurality of beams associated with a second multicast session;
means for receiving a second G-RNTI associated with the second multicast session;
means for receiving, from the base station using a beam from the second list, a second plurality of code blocks comprising multicast data associated with the second multicast session; and
means for descrambling a cyclic redundancy check (CRC) portion of each of the second plurality of code blocks using the second G-RNTI.

63. The wireless communication device of claim 62, wherein receiving the plurality of code blocks comprises:
means for receiving the plurality of code blocks in a first radio resource associated with the beam from the list; and
means for receiving the second plurality of code blocks in a second radio resource associated with the beam from the second list, wherein the first radio resource and the second radio resource are different.

64. A non-transitory processor-readable storage medium storing processor-executable programming for causing a processing circuit to:
transmit, from a user equipment (UE) to a base station, information indicative of a multicast session that the UE is interested in accessing;
transmit information indicating that a first beam of a plurality of beams is a preferred beam for receiving multicast data associated with the multicast session;
receive, from the base station, a list of at least one beam of the plurality of beams associated with the multicast session; and
receive, from the base station using a beam from the list, multicast data associated with the multicast session.

65. The processor-readable storage medium of claim 64, wherein the processor-readable storage medium further comprises processor-executable programming for causing the processing circuit to:
transmit, to the base station, information indicative of channel quality associated with the first beam of a plurality of beams transmitted by the base station.

66. The processor-readable storage medium of claim 65, wherein the processor-readable storage medium further comprises processor-executable programming for causing the processing circuit to:
receive, from the base station, one or more reference signals transmitted using the first beam;
estimate a parameter indicative of channel quality of the first beam using the one or more reference signals; and
wherein the processor-executable programming for transmitting the information indicative of channel quality associated with the first beam comprises processor-executable programming for causing the processing circuit to transmit the parameter indicative of channel quality of the first beam.

67. The processor-readable storage medium of claim 66, wherein the one or more reference signals transmitted using the first beam comprises a synchronization signal block (SSB).

68. The processor-readable storage medium of claim 66, wherein the one or more reference signals transmitted using the first beam comprises a channel state information reference signal (CSI-RS).

69. The processor-readable storage medium of claim 66, wherein the parameter indicative of channel quality is a signal-to-interference-and-noise ratio (SINR) parameter.

70. The processor-readable storage medium of claim 65, wherein the information indicative of channel quality associated with a first beam comprises a channel state information (CSI) report.

71. The processor-readable storage medium of claim 65, wherein the information indicative of channel quality associated with a first beam comprises quasi co-location (QCL) information associated with the first beam.

72. The processor-readable storage medium of claim 65, wherein the information indicative of the preferred beam comprises a beam index associated with the first beam.

73. The processor-readable storage medium of claim 65, wherein the processor-readable storage medium further comprises processor-executable programming for causing the processing circuit to:
select the first beam as the preferred beam for receiving multicast data associated with the multicast session based on the information indicative of channel quality of the first beam.

74. The processor-readable storage medium of claim 64, wherein the processor-executable programming for receiving the list of at least one beam of the plurality of beams associated with the multicast session comprises processor-executable programming for causing the processing circuit to receive one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

75. The processor-readable storage medium of claim 74, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

76. The processor-readable storage medium of claim 64, wherein the list of at least one beam of the plurality of beams associated with the multicast session comprises a plurality of beam indexes corresponding to the at least one beam and at least one second beam associated with the multicast session.

77. The processor-readable storage medium of claim 76, wherein the processor-readable storage medium further comprises processor-executable programming for causing the processing circuit to:
receive, from the base station, a system information block (SIB) comprising a field that indicates the number of bits used to represent each of the plurality of beam indexes.

78. The processor-readable storage medium of claim 64, wherein the list of at least one beam of the plurality of beams associated with the multicast session comprises:
a combination index value i that corresponds to a particular combination of n beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

79. The processor-readable storage medium of claim 78, wherein the list of at least one beam of the plurality of beams associated with the multicast session comprises a value n.

80. The processor-readable storage medium of claim 79, wherein the processor-readable storage medium further comprises processor-executable programming for causing the processing circuit to:
receiving, from the base station, a system information block (SIB) comprising a first field that indicates the number of bits used to convey n, and a second field that indicates the number of bits used to convey the combination index value i.

81. The processor-readable storage medium of claim 64, wherein the processor-executable programming for receiving the list of at least one beam of the plurality of beams associated with the multicast session comprises processor-executable programming for causing the processing circuit to receive the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

82. The processor-readable storage medium of claim 64, wherein the processor-executable programming for receiving the multicast data associated with the multicast session comprises processor-executable programming for causing the processing circuit to receive a plurality of code blocks comprising the multicast data on a physical downlink shared channel (PDSCH) using the beam from the list, and
wherein the processor-readable storage medium further comprises processor-executable programming for causing the processing circuit to:
receive a group radio network temporary identifier (G-RNTI); and
descramble a cyclic redundancy check (CRC) portion of each of the plurality of code blocks using the G-RNTI.

83. The processor-readable storage medium of claim 82, wherein the processor-readable storage medium further comprises processor-executable programming for causing the processing circuit to:
receive, from the base station, a second list of at least one beam of the plurality of beams associated with a second multicast session;
receive a second G-RNTI associated with the second multicast session;
receive, from the base station using a beam from the second list, a second plurality of code blocks comprising multicast data associated with the second multicast session; and
descramble a cyclic redundancy check (CRC) portion of each of the second plurality of code blocks using the second G-RNTI.

84. The processor-readable storage medium of claim 83, wherein the processor-executable programming for receiving the plurality of code blocks comprises processor-executable programming for causing the processing circuit to:
receive the plurality of code blocks in a first radio resource associated with the beam from the list; and
receive the second plurality of code blocks in a second radio resource associated with the beam from the second list, wherein the first radio resource and the second radio resource are different.

85. A method of wireless communication, comprising:
transmitting, to one or more user equipments (UEs), a list of at least one beam of a plurality of beams associated with a multicast session that the one or more UEs are interested in accessing; and
transmitting multicast data associated with the multicast session using the at least one beam from the list.

86. The method of claim 85, further comprising:
receiving, from a first UE of the one or more UEs, information indicating that the first UE is interested in accessing the multicast session.

87. The method of claim 85, further comprising:
receiving, from a first UE, information indicating that a first beam of the plurality of beams is a preferred beam for receiving multicast data associated with the multicast session.

88. The method of claim 87, further comprising:
receiving, from a second UE, information indicating that the first beam and a second beam of the plurality of beams are preferred beams for receiving multicast data associated with the multicast session.

89. The method of claim 88, further comprising:
determining the list of at least one beam based on the information indicating that the first beam is preferred by the first UE and the information indicating that the first beam is preferred by the second UE.

90. The method of claim 89, wherein determining the list further comprises:
selecting the first beam for inclusion in the list of at least one beam; and
excluding the second beam from inclusion in the list of at least one beam.

91. The method of claim 89, wherein determining the list further comprises:
receiving, from the first UE, first information indicative of channel quality associated with the first beam;
receiving, from the second UE, second information indicative of channel quality associated with the first beam;
determining that the first UE and the second UE are covered by the first beam based on the first information indicative of channel quality and the second information indicative of channel quality; and
selecting the first beam for inclusion in the list of at least one beam in response to determining that that the first UE and the second UE are covered by the first beam.

92. The method of claim 87, further comprising:
transmitting one or more reference signals using the first beam;
receiving, from the first UE, information indicative of channel quality associated with the first beam.

93. The method of claim 92, wherein the one or more reference signals transmitted using the first beam comprises a synchronization signal block (SSB).

94. The method of claim 92, wherein the one or more reference signals transmitted using the first beam comprises a channel state information reference signal (CSI-RS).

95. The method of claim 92, wherein the parameter indicative of channel quality is a signal-to-interference-and-noise ratio (SINR) parameter.

96. The method of claim 92, wherein the information indicative of channel quality associated with a first beam comprises a channel state information (CSI) report.

97. The method of claim 92, wherein the information indicative of channel quality associated with a first beam comprises quasi co-location (QCL) information associated with the first beam.

98. The method of claim 87, wherein the information indicative of the preferred beam comprises a beam index associated with the first beam.

99. The method of claim 85, wherein transmitting the list of at least one beam of the plurality of beams associated with the multicast session comprises transmitting one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

100. The method of claim 85, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

101. The method of claim 85, wherein the list of at least one beam of the plurality of beams associated with the multicast session comprises a plurality of beam indexes corresponding to the at least one beam and at least one second beam associated with the multicast session.

102. The method of claim 101, further comprising:
transmitting a system information block (SIB) comprising a field that indicates the number of bits used to represent each of the plurality of beam indexes.

103. The method of claim 85, wherein the list of at least one beam of the plurality of beams associated with the multicast session comprises:
a combination index value i that corresponds to a particular combination of beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

104. The method of claim 103, wherein the list of at least one beam of the plurality of beams associated with the multicast session comprises a value n.

105. The method of claim 103, further comprising:
transmitting a system information block (SIB) comprising a first field that indicates the number of bits used to convey n, and a second field that indicates the number of bits used to convey the combination index value i.

106. The method of claim 85, wherein transmitting the list of at least one beam of the plurality of beams associated with the multicast session comprises transmitting the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

107. The method of claim 85, wherein transmitting the multicast data associated with the multicast session comprises transmitting a plurality of code blocks comprising the multicast data on a physical downlink shared channel (PDSCH) using the at least one beam, and
wherein the method further comprises:
transmitting, to the one or more UEs, a group radio network temporary identifier (G-RNTI); and
scrambling a cyclic redundancy check (CRC) portion of each of the plurality of code blocks using the G-RNTI.

108. The method of claim 107, further comprising:
transmitting, to the one or more UEs, a second list of at least one beam of the plurality of beams associated with a second multicast session;
transmitting, to the one or more UEs, a second G-RNTI associated with the second multicast session;
transmitting, using a beam from the second list, a second plurality of code blocks comprising multicast data associated with the second multicast session; and
scrambling a cyclic redundancy check (CRC) portion of each of the second plurality of code blocks using the second G-RNTI.

109. The method of claim 108, wherein transmitting the plurality of code blocks comprises:
transmitting the plurality of code blocks using a first radio resource associated with a first beam from the list; and
transmitting the second plurality of code blocks using a second radio resource associated with a second beam from the second list, wherein the first radio resource and the second radio resource are different.

110. A scheduling entity, comprising:
a transceiver;
a network interface;
memory; and
a processor communicatively coupled to the transceiver and the memory, the processor configured to:
transmit, to one or more user equipments (UEs) via the transceiver, a list of at least one beam of a plurality of beams associated with a multicast session that the one or more UEs are interested in accessing; and
transmit, via the transceiver, multicast data associated with the multicast session using the at least one beam from the list.

111. The scheduling entity of claim 110, wherein the processor is further configured to:
receive, from a first UE of the one or more UEs, information indicating that the first UE is interested in accessing the multicast session.

112. The scheduling entity of claim 110, wherein the processor is further configured to:
receive, from a first UE, information indicating that a first beam of the plurality of beams is a preferred beam for receiving multicast data associated with the multicast session.

113. The scheduling entity of claim 112, wherein the processor is further configured to:
receive, from a second UE, information indicating that the first beam and a second beam of the plurality of beams are preferred beams for receiving multicast data associated with the multicast session.

114. The scheduling entity of claim 113, wherein the processor is further configured to:
determine the list of at least one beam based on the information indicating that the first beam is preferred by the first UE and the information indicating that the first beam is preferred by the second UE.

115. The scheduling entity of claim 114, wherein the processor is further configured to:
select the first beam for inclusion in the list of at least one beam; and
exclude the second beam from inclusion in the list of at least one beam.

116. The scheduling entity of claim 114, wherein the processor is further configured to:
receive, from the first UE, first information indicative of channel quality associated with the first beam;
receive, from the second UE, second information indicative of channel quality associated with the first beam;
determine that the first UE and the second UE are covered by the first beam based on the first information indicative of channel quality and the second information indicative of channel quality; and
select the first beam for inclusion in the list of at least one beam in response to determining that that the first UE and the second UE are covered by the first beam.

117. The scheduling entity of claim 112, the processor is further configured to:
transmit, via the transceiver, one or more reference signals using the first beam;
receive, from the first UE, information indicative of channel quality associated with the first beam.

118. The scheduling entity of claim 117, wherein the one or more reference signals transmitted using the first beam comprises a synchronization signal block (SSB).

119. The scheduling entity of claim 117, wherein the one or more reference signals transmitted using the first beam comprises a channel state information reference signal (CSI-RS).

120. The scheduling entity of claim 117, wherein the parameter indicative of channel quality is a signal-to-interference-and-noise ratio (SINR) parameter.

121. The scheduling entity of claim 117, wherein the information indicative of channel quality associated with a first beam comprises a channel state information (CSI) report.

122. The scheduling entity of claim 117, wherein the information indicative of channel quality associated with a first beam comprises quasi co-location (QCL) information associated with the first beam.

123. The scheduling entity of claim 122, wherein the information indicative of the preferred beam comprises a beam index associated with the first beam.

124. The scheduling entity of claim 110, wherein the processor is further configured to:
transmit, via the transceiver, the list of at least one beam of the plurality of beams associated with the multicast session via one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

125. The scheduling entity of claim 110, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

126. The scheduling entity of claim 110, wherein the list of at least one beam of the plurality of beams associated with the multicast session comprises a plurality of beam indexes corresponding to the at least one beam and at least one second beam associated with the multicast session.

127. The scheduling entity of claim 126, wherein the processor is further configured to:
transmit, via the transceiver, a system information block (SIB) comprising a field that indicates the number of bits used to represent each of the plurality of beam indexes.

128. The scheduling entity of claim 110, wherein the list of at least one beam of the plurality of beams associated with the multicast session comprises:
a combination index value i that corresponds to a particular combination of beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

129. The scheduling entity of claim 128, wherein the list of at least one beam of the plurality of beams associated with the multicast session comprises a value n.

130. The scheduling entity of claim 128, wherein the processor is further configured to:
transmitting a system information block (SIB) comprising a first field that indicates the number of bits used to convey n, and a second field that indicates the number of bits used to convey the combination index value i.

131. The scheduling entity of claim 110, wherein the processor is further configured to transmit the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

132. The scheduling entity of claim 110, wherein transmitting the multicast data associated with the multicast session comprises transmitting a plurality of code blocks comprising the multicast data on a physical downlink shared channel (PDSCH) using the at least one beam, and
wherein the processor is further configured to
transmit, to the one or more UEs, a group radio network temporary identifier (G-RNTI); and
scramble a cyclic redundancy check (CRC) portion of each of the plurality of code blocks using the G-RNTI.

133. The scheduling entity of claim 132, wherein the processor is further configured to
transmit, to the one or more UEs, a second list of at least one beam of the plurality of beams associated with a second multicast session;
transmit, to the one or more UEs, a second G-RNTI associated with the second multicast session;
transmit, using a beam from the second list, a second plurality of code blocks comprising multicast data associated with the second multicast session; and
scramble a cyclic redundancy check (CRC) portion of each of the second plurality of code blocks using the second G-RNTI.

134. The scheduling entity of claim 133, wherein the processor is further configured to:
transmit, via the transceiver, the plurality of code blocks using a first radio resource associated with a first beam from the list; and
transmit, via the transceiver, the second plurality of code blocks using a second radio resource associated with a second beam from the second list, wherein the first radio resource and the second radio resource are different.

135. A scheduling entity, comprising:
means for transmitting, to one or more user equipments (UEs), a list of at least one beam of a plurality of beams associated with a multicast session that the one or more UEs are interested in accessing; and
means for transmitting multicast data associated with the multicast session using the at least one beam from the list.

136. The scheduling entity of claim 135, further comprising:
means for receiving, from a first UE of the one or more UEs, information indicating that the first UE is interested in accessing the multicast session.

137. The scheduling entity of claim 135, further comprising:
means for receiving, from a first UE, information indicating that a first beam of the plurality of beams is a preferred beam for receiving multicast data associated with the multicast session.

138. The scheduling entity of claim 137, further comprising:
means for receiving, from a second UE, information indicating that the first beam and a second beam of the plurality of beams are preferred beams for receiving multicast data associated with the multicast session.

139. The scheduling entity of claim 138, further comprising:
means for determining the list of at least one beam based on the information indicating that the first beam is preferred by the first UE and the information indicating that the first beam is preferred by the second UE.

140. The scheduling entity of claim 139, wherein the means for determining the list further comprises:
means for selecting the first beam for inclusion in the list of at least one beam; and
means for excluding the second beam from inclusion in the list of at least one beam.

141. The scheduling entity of claim 139, wherein the means for determining the list further comprises:
means for receiving, from the first UE, first information indicative of channel quality associated with the first beam;
means for receiving, from the second UE, second information indicative of channel quality associated with the first beam;
means for determining that the first UE and the second UE are covered by the first beam based on the first information indicative of channel quality and the second information indicative of channel quality; and
means for selecting the first beam for inclusion in the list of at least one beam in response to determining that that the first UE and the second UE are covered by the first beam.

142. The scheduling entity of claim 137, further comprising:
means for transmitting one or more reference signals using the first beam;
means for receiving, from the first UE, information indicative of channel quality associated with the first beam.

143. The scheduling entity of claim 142, wherein the one or more reference signals transmitted using the first beam comprises a synchronization signal block (SSB).

144. The scheduling entity of claim 142, wherein the one or more reference signals transmitted using the first beam comprises a channel state information reference signal (CSI-RS).

145. The scheduling entity of claim 142, wherein the parameter indicative of channel quality is a signal-to-interference-and-noise ratio (SINR) parameter.

146. The scheduling entity of claim 142, wherein the information indicative of channel quality associated with a first beam comprises a channel state information (CSI) report.

147. The scheduling entity of claim 142, wherein the information indicative of channel quality associated with a first beam comprises quasi co-location (QCL) information associated with the first beam.

148. The scheduling entity of claim 137, wherein the information indicative of the preferred beam comprises a beam index associated with the first beam.

149. The scheduling entity of claim 135, wherein transmitting the list of at least one beam of the plurality of beams associated with the multicast session transmits the list of at least one beam comprises transmitting one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

150. The scheduling entity of claim 135, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

151. The scheduling entity of claim 135, wherein the list of at least one beam of the plurality of beams associated with the multicast session comprises a plurality of beam indexes corresponding to the at least one beam and at least one second beam associated with the multicast session.

152. The scheduling entity of claim 151, further comprising:
means for transmitting a system information block (SIB) comprising a field that indicates the number of bits used to represent each of the plurality of beam indexes.

153. The scheduling entity of claim 135, wherein the list of at least one beam of the plurality of beams associated with the multicast session comprises:
a combination index value i that corresponds to a particular combination of beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

154. The scheduling entity of claim 153, wherein the list of at least one beam of the plurality of beams associated with the multicast session comprises a value n.

155. The scheduling entity of claim 153, further comprising:
means for transmitting a system information block (SIB) comprising a first field that indicates the number of bits used to convey n, and a second field that indicates the number of bits used to convey the combination index value i.

156. The scheduling entity of claim 135, wherein the means for transmitting the list of at least one beam of the plurality of beams associated with the multicast session transmits the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

157. The scheduling entity of claim 135, wherein the means for transmitting the multicast data associated with the multicast session comprises means for transmitting a plurality of code blocks comprising the multicast data on a physical downlink shared channel (PDSCH) using the at least one beam, and
wherein the scheduling entity further comprises:
means for transmitting, to the one or more UEs, a group radio network temporary identifier (G-RNTI); and
means for scrambling a cyclic redundancy check (CRC) portion of each of the plurality of code blocks using the G-RNTI.

158. The scheduling entity of claim 157, further comprising:
means for transmitting, to the one or more UEs, a second list of at least one beam of the plurality of beams associated with a second multicast session;
means for transmitting, to the one or more UEs, a second G-RNTI associated with the second multicast session;
means for transmitting, using a beam from the second list, a second plurality of code blocks comprising multicast data associated with the second multicast session; and
means for scrambling a cyclic redundancy check (CRC) portion of each of the second plurality of code blocks using the second G-RNTI.

159. The scheduling entity of claim 158, wherein transmitting the plurality of code blocks comprises:
means for transmitting the plurality of code blocks using a first radio resource associated with a first beam from the list; and
means for transmitting the second plurality of code blocks using a second radio resource associated with a second beam from the second list, wherein the first radio resource and the second radio resource are different.

160. A non-transitory processor-readable storage medium storing processor-executable programming for causing a processing circuit to:
transmit, to one or more user equipments (UEs), a list of at least one beam of a plurality of beams associated with a multicast session that the one or more UEs are interested in accessing; and
transmit multicast data associated with the multicast session using the at least one beam from the list.

161. The processor-readable storage medium of claim 160, wherein the processor-readable storage medium further comprises processor-executable programming for causing the processing circuit to:
receive, from a first UE of the one or more UEs, information indicating that the first UE is interested in accessing the multicast session.

162. The processor-readable storage medium of claim 160, wherein the processor-readable storage medium further comprises processor-executable programming for causing the processing circuit to:
receive, from a first UE, information indicating that a first beam of the plurality of beams is a preferred beam for receiving multicast data associated with the multicast session.

163. The processor-readable storage medium of claim 162, wherein the processor-readable storage medium further comprises processor-executable programming for causing the processing circuit to:
receive, from a second UE, information indicating that the first beam and a second beam of the plurality of beams are preferred beams for receiving multicast data associated with the multicast session.

164. The processor-readable storage medium of claim 163, wherein the processor-readable storage medium further comprises processor-executable programming for causing the processing circuit to:
determine the list of at least one beam based on the information indicating that the first beam is preferred by the first UE and the information indicating that the first beam is preferred by the second UE.

165. The processor-readable storage medium of claim 164, wherein the processor-executable programming for determining the list comprises processor-executable programming for causing the processing circuit to:
select the first beam for inclusion in the list of at least one beam; and
exclude the second beam from inclusion in the list of at least one beam.

166. The processor-readable storage medium of claim 164, wherein the processor-executable programming for determining the list comprises processor-executable programming for causing the processing circuit to:
receive, from the first UE, first information indicative of channel quality associated with the first beam;
receive, from the second UE, second information indicative of channel quality associated with the first beam;
determine that the first UE and the second UE are covered by the first beam based on the first information indicative of channel quality and the second information indicative of channel quality; and
select the first beam for inclusion in the list of at least one beam in response to determining that that the first UE and the second UE are covered by the first beam.

167. The processor-readable storage medium of claim 162, wherein the processor-readable storage medium further comprises processor-executable programming for causing the processing circuit to:
transmit one or more reference signals using the first beam;
receive, from the first UE, information indicative of channel quality associated with the first beam.

168. The processor-readable storage medium of claim 167, wherein the one or more reference signals transmitted using the first beam comprises a synchronization signal block (SSB).

169. The processor-readable storage medium of claim 167, wherein the one or more reference signals transmitted using the first beam comprises a channel state information reference signal (CSI-RS).

170. The processor-readable storage medium of claim 167, wherein the parameter indicative of channel quality is a signal-to-interference-and-noise ratio (SINR) parameter.

171. The processor-readable storage medium of claim 167, wherein the information indicative of channel quality associated with a first beam comprises a channel state information (CSI) report.

172. The processor-readable storage medium of claim 167, wherein the information indicative of channel quality associated with a first beam comprises quasi co-location (QCL) information associated with the first beam.

173. The processor-readable storage medium of claim 162, wherein the information indicative of the preferred beam comprises a beam index associated with the first beam.

174. The processor-readable storage medium of claim 160, wherein transmitting the list of at least one beam of the plurality of beams associated with the multicast session comprises transmitting one or more of the following: a radio resource control (RRC) message; a media access control (MAC) control element (CE); or downlink control information (DCI), wherein the DCI is group-common DCI, DCI directed to the UE, or group-common DCI and DCI directed to the UE.

175. The processor-readable storage medium of claim 160, wherein the list of at least one beam of the plurality of beams associated with the multicast session comprises at least one quasi-co-location (QCL) information value that is associated with the at least one beam, and
wherein the DCI comprises a transmission configuration indication (TCI) field that includes the at least one QCL information value.

176. The processor-readable storage medium of claim 160, wherein the list of at least one beam of the plurality of beams associated with the multicast session comprises a plurality of beam indexes corresponding to the at least one beam and at least one second beam associated with the multicast session.

177. The processor-readable storage medium of claim 176, wherein the processor-readable storage medium further comprises processor-executable programming for causing the processing circuit to:
transmit a system information block (SIB) comprising a field that indicates the number of bits used to represent each of the plurality of beam indexes.

178. The processor-readable storage medium of claim 177, wherein the list of at least one beam of the plurality of beams associated with the multicast session comprises:
a combination index value i that corresponds to a particular combination of beams in a combination index Cₘⁿ, where n is the number of selected beams associated with the multicast session and m is the number of selectable beams; or
a combination index value i that corresponds to a particular combination of n beams in a combination index Cₘ that includes index values corresponding to combinations of any number of beams of the m selectable beams.

179. The processor-readable storage medium of claim 178, wherein the list of at least one beam of the plurality of beams associated with the multicast session comprises a value n.

180. The processor-readable storage medium of claim 178, further comprising:
transmit a system information block (SIB) comprising a first field that indicates the number of bits used to convey n, and a second field that indicates the number of bits used to convey the combination index value i.

181. The processor-readable storage medium of claim 160, wherein the processor-executable programming for transmitting the list of at least one beam of the plurality of beams associated with the multicast session comprises processor-executable programming for causing the processing circuit to transmit the list of at least one beam of the plurality of beams associated with the multicast session on a physical data control channel (PDCCH) via one or more of the following:
a wide beam that covers at least two of the plurality of beams;
a beam of the plurality of beams; or
the beam from the list that is used to receive the multicast data associated with the multicast session.

182. The processor-readable storage medium of claim 160, wherein the processor-executable programming transmitting the multicast data associated with the multicast session comprises processor-executable programming for causing the processing circuit to transmit a plurality of code blocks comprising the multicast data on a physical downlink shared channel (PDSCH) using the at least one beam, and
wherein the processor-readable storage medium further comprises processor-executable programming for causing the processing circuit to:
transmit, to the one or more UEs, a group radio network temporary identifier (G-RNTI); and
scramble a cyclic redundancy check (CRC) portion of each of the plurality of code blocks using the G-RNTI.

183. The processor-readable storage medium of claim 182, wherein the processor-readable storage medium further comprises processor-executable programming for causing the processing circuit to:
transmit, to the one or more UEs, a second list of at least one beam of the plurality of beams associated with a second multicast session;
transmit, to the one or more UEs, a second G-RNTI associated with the second multicast session;
transmit, using a beam from the second list, a second plurality of code blocks comprising multicast data associated with the second multicast session; and
scramble a cyclic redundancy check (CRC) portion of each of the second plurality of code blocks using the second G-RNTI.

184. The processor-readable storage medium of claim 183, wherein the processor-executable programming for transmitting the plurality of code blocks comprises processor-executable programming for causing the processing circuit to:
transmit the plurality of code blocks using a first radio resource associated with a first beam from the list; and
transmit the second plurality of code blocks using a second radio resource associated with a second beam from the second list, wherein the first radio resource and the second radio resource are different.

185. An apparatus for wireless communication, comprising:
means for performing one or more functions described in the Specification and claims provided above.

186. An apparatus for wireless communication, comprising:
one or more features described in the Specification and claims provided above.

187. A non-transitory computer-readable medium storing computer-executable code, comprising code for causing a computer to:
carry out one or more processes described in the Specification and claims provided above.

188. An apparatus for wireless communication, comprising:
a processor;
a transceiver communicatively coupled to the at least one processor; and
a memory communicatively coupled to the at least one processor,
wherein the processor is configured to:
carry out one or more processes described in the Specification and claims provided above.
